(19) United States
(12) Patent Application Publication
(10) Pub. No.: US 2023/0008912 A1
(43) Pub. Date: Jan. 12, 2023

(54) MENU RECOMMENDATION SYSTEM, MENU RECOMMENDATION METHOD, RECORDING MEDIUM, INFORMATION PROCESSING METHOD, AND INFORMATION PROCESSING DEVICE

(71) Applicant: Panasonic Intellectual Property Management Co., Ltd., Osaka (JP)

(72) Inventors: Mitsuhiro ASO, Shiga (JP); Nobue NARITA, Osaka (JP); Yoshitsugu URIU, Osaka (JP)

(21) Appl. No.: 17/772,957

(22) PCT Filed: Feb. 18, 2021
(86) PCT No.: PCT/JP2021/006225

§ 371 Date: Apr. 28, 2022

(30) Foreign Application Priority Data
Feb. 21, 2020 (JP) 2020-027810
Feb. 17, 2021 (JP) 2021-023267

(51) Int. Cl. G06Q 30/02; G06Q 50/12

(52) U.S. Cl. CPC G06Q 30/0271; G06Q 50/12

(57) ABSTRACT

A server as an example of a menu recommendation system includes an evaluator, a processing unit, and an actual usage record acquirer. The evaluator recommends menus for a target period. The processing unit presents the menus recommended by the evaluator to a user. The actual usage record acquirer acquires, from the user, an actual usage record of the menus recommended by the evaluator at an arbitrary timing in the target period. When a difference occurs between first information regarding content of the menus recommended by the evaluator and second information regarding the actual usage record during a period from a start of the target period to the timing, the evaluator performs reward processing of rewarding the user according to the difference or re-recommendation processing of re-recommending menus for a remaining period by changing the content of the recommended menus.

### CROSS-REFERENCE TO RELATED APPLICATIONS

This application is the U.S. National Phase under 35 U.S.C. § 371 of International Patent Application No. PCT/JP2021/006225, filed on Feb. 18, 2021, which in turn claims the benefit of Japanese Application No. 2020-027810, filed on Feb. 21, 2020, and Japanese Application No. 2021-023267, filed on Feb. 17, 2021, the entire disclosures of each of which applications are incorporated by reference herein in their entirety.

### TECHNICAL FIELD

The present invention relates generally to a menu recommendation system, a menu recommendation method, a recording medium, an information processing method, and an information processing device. More specifically, the present invention relates to a menu recommendation system, a menu recommendation method, a recording medium, an information processing method, and an information processing device that recommend menus for a target period.

### BACKGROUND ART

Patent Literature (PTL) 1 discloses an information processing device for improving the efficiency of shopping. The information processing device includes a planned purchase price amount acquirer, a target purchase price amount acquirer, and a merchandise information outputter. The planned purchase price amount acquirer acquires a planned purchase price amount. The planned purchase price amount refers to the total price of merchandise to be purchased by a customer. The target purchase price amount acquirer acquires a target purchase price amount. The merchandise information outputter determines merchandise based on the difference between the target purchase price amount and the planned purchase price amount. Then, the merchandise information outputter outputs merchandise information regarding the determined merchandise.

### CITATION LIST

### Patent Literature

[PTL 1] Japanese Unexamined Patent Application Publication No. 2017-182554

### SUMMARY OF INVENTION

### Technical Problem

The information processing device disclosed in PTL 1 determines merchandise (food ingredients) based on the difference between the target purchase price amount and the planned purchase price amount such that the total price of merchandise will be within the target purchase price amount when the customer shops in a store. However, in the case of recommending, for example, menus for a target period, when the menus (food ingredients and the like) are determined simply based on the difference (the amount of money) between the target purchase price amount (target value) and the planned purchase price amount, the recommended menus may not be the menus actually desired by the customer (user).

The present disclosure has been made in view of the problem described above, and it is an object of the present disclosure to provide a menu recommendation system, a menu recommendation method, a recording medium, an information processing method, and an information processing device, with which it is possible to improve the content of recommended menus.

### Solution to Problem

A menu recommendation system according to one aspect of the present disclosure includes an evaluator, a processing unit, and an actual usage record acquirer. The evaluator recommends menus for a target period. The processing unit presents the menus recommended by the evaluator to a user. The actual usage record acquirer acquires an actual usage record of the menus recommended by the evaluator from the user at an arbitrary timing in the target period. When a difference occurs between first information regarding content of the menus recommended by the evaluator and second information regarding the actual usage record acquired by the actual usage record acquirer during a period from a start of the target period to the arbitrary timing, the evaluator performs at least one of reward processing of giving a reward to the user according to the difference or re-recommendation processing of re-recommending menus for a remaining period that is after the arbitrary timing in the target period by changing the content of the recommended menus.

A menu recommendation method according to one aspect of the present disclosure includes: performing evaluation to recommend menus for a target period; performing processing to present the menus recommended in the performing of the evaluation to a user; and acquiring an actual usage record of the menus recommended in the performing of the evaluation from the user at an arbitrary timing in the target period. The evaluating includes, when a difference occurs between first information regarding content of the menus recommended in the performing of the evaluation and second information regarding the actual usage record acquired in the acquiring during a period from a start of the target period to the arbitrary timing, performing at least one of reward processing of giving a reward to the user according to the difference or re-recommendation processing of re-recommending menus for a remaining period that is after the arbitrary timing in the target period by changing the content of the recommended menus.

A recording medium according to one aspect of the present disclosure is a non-transitory computer-readable recording medium storing a program that causes one or more processors to execute the menu recommendation method described above.

An information processing method according to one aspect of the present disclosure includes first processing, second processing, and third processing. The first processing includes acquiring menus for a target period and presenting the menus acquired to a user. The second processing includes acquiring an actual usage record of the menus presented in the first processing from the user at an arbitrary timing in the target period. The third processing includes, when a difference occurs between first information regarding content of the menus recommended in the first processing and second information regarding the actual usage record acquired in the second processing during a period from a start of the target period to the arbitrary timing, performing at least one of reward processing of giving a reward to the user according to the difference or re-recommendation processing of re-recommending menus for a remaining period that is after the arbitrary timing in the target period by changing the content of the recommended menus.

An information processing device according to one aspect of the present disclosure includes a processing unit. The processing unit includes a first processing function, a second processing function, and a third processing function. The first processing includes acquiring menus for a target period and presenting the menus acquired to a user. The second processing includes acquiring an actual usage record of the menus presented in the first processing from the user at an arbitrary timing in the target period. The third processing includes, when a difference occurs between first information regarding content of the menus recommended in the first processing and second information regarding the actual usage record acquired in the second processing during a period from a start of the target period to the arbitrary timing, performing at least one of reward processing of giving a reward to the user according to the difference or re-recommendation processing of re-recommending menus for a remaining period that is after the arbitrary timing in the target period by changing content of the menus recommended.

### Advantageous Effects of Invention

According to the present disclosure, it is possible to provide an advantage in that the content of the recommended menus can be improved.

### BRIEF DESCRIPTION OF DRAWINGS

FIG. 1 is a schematic configuration diagram of a menu assisting system that includes a menu recommendation system according to an embodiment.

FIG. 2 is a block configuration diagram of a presentation device that is included in the menu assisting system.

FIG. 3A is a diagram illustrating a target period in the menu assisting system.

FIG. 3B is a conceptual diagram of condition information in the menu assisting system.

FIG. 4 is a flowchart diagram illustrating operations performed in the menu assisting system.

FIG. 5 is a block configuration diagram of a menu recommendation system used in Examples 1 to 4 of the embodiment.

FIG. 6 is a flowchart diagram illustrating operations performed in the menu recommendation system according to Example 1 of the embodiment.

FIG. 7 is a flowchart diagram illustrating operations performed in the menu recommendation system according to Example 2 of the embodiment.

FIG. 8 is a flowchart diagram illustrating operations performed in the menu recommendation system according to Example 3 of the embodiment.

FIG. 9 is a flowchart diagram illustrating operations performed in the menu recommendation system according to Example 4 of the embodiment.

### DESCRIPTION OF EMBODIMENT

### (1) Overview

The diagrams used in an embodiment given below are schematic representations, and thus the ratio of size and thickness of each structural element illustrated in the diagrams does not necessarily reflect the actual scale.

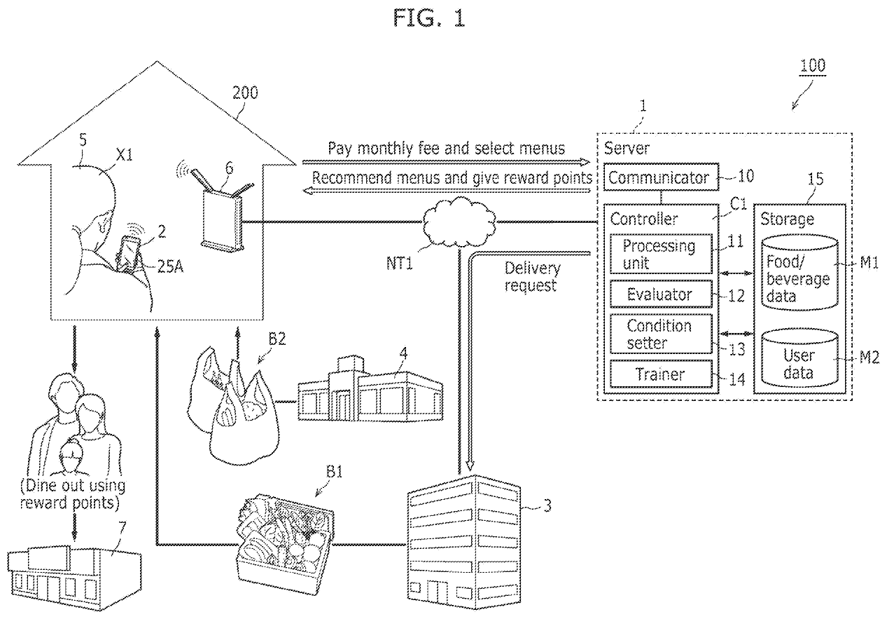

A menu recommendation system (here, server 1, see FIG. 1) according to an aspect of the present embodiment recommends menus for target period T1 based on target value A1 (see FIG. 3A) of a food cost for target period T1. The menus (information) are recommended to user 5 (see FIG. 1) who uses the menu recommendation system.

The term “menu information” used in the specification of the present application is intended to encompass information regarding recipes (cooking methods) including cooking menus (names), the names of food ingredients to be used, the types of food ingredients (categories including meat, seafood, beans, grains, fresh vegetables, fresh fruits, mushrooms, and the like), as well as the amount and size of each food ingredient, and the like. Here, as an example, the menu recommendation system recommends not only menus, but also information such as prepared meal information or dining-out information (store information such as restaurants). I other words, the menu recommendation system is configured to be capable of recommending not only meals cooked at home or the like, but also meals provided by food-serving facilities. Hereinafter, irrespective of the number of items in menus (irrespective of whether the number of items in menus is one or more), cooking menus and recipes may also be collectively referred to simply as “menus”. In other words, the term “menus” as used herein encompasses information regarding one or more recipes.

Attention is being paid to so-called “subscription service” that is a fee payment service. The subscription service is a service in which, for example, when a user makes a contract of the service for a fixed effective period (one month, one year, or the like) and pays the fee for the service, the user can continuously use anything provided by the service during the fixed effective period. The present embodiment will be described based on the assumption that, as an example, the menu recommendation system is used in a subscription service.

User 5 who uses the menu recommendation system makes a contract with a provider who provides the menu recommendation system (hereinafter referred to as “menu provider”), and pays a monthly fee (fixed charge) of, for example, 30,000 yen to the menu provider. As a result, the menu recommendation system sets a food cost of 30,000 yen as target value A1, and recommends menus for one month (target period T1). Also, the menu provider is under contract with food ingredients delivery service provider 3 (see FIG. 1), and transmits a delivery request for delivering food ingredients B1 that are required for the menus determined by user 5. In response to receiving the delivery request, food ingredients delivery service provider 3 delivers food ingredients B1 requested by the delivery request to the house (house 200) of user 5. In short, the menu recommendation system is configured to be capable of providing, to user 5, a menu recommendation service with a fixed charge combined with a delivery service for delivering food ingredients B1.

The following description will be given on the assumption that, as an example, the menu recommendation system is used by one of the family members of house 200. For the sake of convenience of the description, it is assumed that, for example, among the family members of house 200, mother (meal preparer X1) who prepares home-cooked meals at home uses the menu recommendation system. However, there is no particular limitation on the number of users 5 who use the menu recommendation system, and user 5 may be any of family members (mother, father, and children). Also, the menu recommendation system may be used by an organization or a group. The following description will be given on the assumption that target period T1 during which menus are recommended is one month, but target period T1 is not limited thereto, and target period T1 may be one day, one week, several months, one year, or the like.

Here, as shown in FIG. 1, the menu recommendation system (server 1) includes evaluator 12 and processing unit 11. Evaluator 12 performs evaluation on menus at arbitrary timing t1 in target period T1. Processing unit 11 performs predetermined processing based on the result of the evaluation performed by evaluator 12. Evaluator 12 performs the evaluation based on first information regarding the content of the recommended menus and second information regarding an actual usage record of the recommended menus. The first information and the second information are both information during a period from the start of target period T1 to timing t1.

Although details will be given later, the term “actual usage record” of menus as used herein may include an actual usage record of recommended menus that were accepted by user 5, an actual usage record of recommended menus that were rejected (cancelled) by user 5, and the like. The number of recommended menus is not limited to one, and may be two or more. When the number of recommended menu is two or more, the actual usage record of the menus also includes an actual usage record indicating which menus were accepted and which menus were rejected. Furthermore, the actual usage record of the menus may also include an actual usage record indicating menus that were accepted by user 5 after a portion of the content of the menus (for example, some food ingredients) had been changed.

The predetermined processing used herein may include processing of presenting, to user 5, menus obtained as a result of the evaluation. Also, the predetermined processing used herein may include processing of giving a reward according to the difference between the first information and the second information. Furthermore, the predetermined processing used herein may include processing of changing the content of menus for remaining period T2 (see FIG. 3A) that is after timing t1 in target period T1.

With the menu recommendation system according to the present embodiment, the menu evaluation performed at arbitrary timing t1 is performed based on the recommended menus (recommendation history) that were recommended until timing t1 and the actual usage record of the menus (acceptance/rejection history). Then, predetermined processing is performed based on the result of the evaluation. Accordingly, it is possible to recommend updated menus that reflect, in addition to the elements (the remainder of the food cost, and the like) that vary on a daily basis, the past recommendation history and the acceptance/rejection history in target period T1. As a result, it is possible to provide an advantage in that the content of the recommended menus can be improved.

In the present embodiment, the recommended menus (information) are output (presented) from presentation device 2 (see FIG. 1) that corresponds to an information terminal owned (for example, carried) by user 5. The information terminal as used herein is, for example, a smart phone, a tablet terminal, or the like. The term “presented” used herein is intended to mean, for example, that display 25A (see FIG. 1) that includes a touch panel liquid crystal display or an organic EL (Electro-Luminescent) display outputs the menus to a screen. However, presentation device 2 is not limited to a portable terminal, and may be, for example, a stationary personal computer. Also, the way the menu is presented is not limited to outputting the menus to a screen, and the menus may be presented by outputting a voice sound instead of or in addition to outputting the menus to a screen. For example, presentation device 2 may be implemented using a so-called AI speaker that is a smart speaker to which artificial intelligence (AI) technology is applied. Presentation device 2 may be a smart television set. In the case where presentation device 2 is not a portable terminal, presentation device 2 may be installed in the kitchen or the like of house 200.

The menu information presented from presentation device 2 may include text information and image information (still images or moving images) regarding cooking menus and recipes.

A menu recommendation method according to another aspect of the present embodiment recommends menus for target period T1 based on a target value of a food cost for target period T1. The menu recommendation method includes an evaluation step and a processing step. In the evaluation step, menu evaluation is performed at an arbitrary timing in target period T1. In the processing step, predetermined processing is performed based on the result of the evaluation performed in the evaluation step. In the evaluation step, the evaluation is performed based on first information regarding the content of the recommended menus and second information regarding the actual usage record of the recommended menus during a period from the start of target period T1 to timing t1.

With this menu recommendation method as well, it is possible to provide an advantage in that the content of the recommended menus can be improved.

In the present embodiment, it is assumed that all of the functions of the menu recommendation system (for example, the functions of evaluator 12 and processing unit 11) are aggregated and incorporated in server 1 that is capable of performing communication with one or more presentation devices 2. Accordingly, hereinafter, the menu recommendation system may also be referred to as “server 1”. However, at least one of the functions of the menu recommendation system may be incorporated in a device other than server 1. Here, it is assumed that server 1 is composed of one server device. However, server 1 may be composed of a plurality of server devices, and the plurality of server devices may construct, for example, a cloud (cloud computing).

The menu recommendation system according to the present embodiment manages, for example, history information (recommendation history, acceptance/rejection history, and the like) of user 5, performs machine learning to determine menus that more suit the lifestyle pattern (lifestyle habits and lifestyle rhythm), and the likes and dislikes of user 5, and recommends the menus.

### (2) Details

Hereinafter, a configuration of menu assisting system 100 that includes a menu recommendation system (server 1) according to the present embodiment will be described in detail with reference to FIGS. 1 to 4.

### (2.1) Overall Configuration

As described above, server 1 recommends menus for target period T1 based on target value A1 (for example, 30,000 yen) of the food cost for target period T1 (for example, one month). Here, as an example, as shown in FIG. 3A, target period T1 is one month from April 1 to 30. As described above, the food cost for target period T1 is set in advance as a fixed charge (for example, 30,000 yen). User 5 who uses server 1 can receive menu recommendations by paying a fixed charge of 30,000 yen to the menu provider as the food cost for April. Furthermore, user 5 can also receive a service (delivery service) in which when user 5 indicates an acceptance of recommended menu, food ingredients delivery service provider 3 delivers food ingredients B1 required for the recommended menus to house 200.

For example, when server 1 receives a recommendation request for recommendation of menus for one month from April 1 to 30 (a menu plan for one month) from user 5 on a date (for example, on March 30) prior to April 1, server 1 performs recommendation processing of recommending menus in response to the recommendation request from user 5. Hereinafter, this will be referred to as “initial recommendation”. In the initial recommendation, for example, menus (draft recommendation) for one month from April 1 to 30 determined based on target value A1 (for example, 30,000 yen) are recommended. Also, server 1 can also receive a recommendation request from user 5 at arbitrary timing t1 (on April 7 in the example shown in FIG. 3A) after the start of target period T1. Hereinafter, a recommendation made at second and subsequent times after the initial recommendation will be referred to as “in-period recommendation”. A request for an in-period recommendation can be made an unlimited number of times as long as the request is made during the period from April 1 to 30. The in-period recommendation is a menu recommendation for a period after timing t1 determined based on the remainder of the food cost at arbitrary timing t1. The menu recommendation after timing t1 may include menus for the remaining period from timing t1 to the final day (April 30), menus for a period from timing t1 to a date prior to the final day, or menus for one day such as timing t1.

Menu assisting system 100 includes one or more presentation devices 2 and server 1 (menu recommendation system). Menu assisting system 100 further includes router 6 that is installed in house 200. Here, as described above, a description will be given focusing on mother (user 5) from among the family members of house 200. That is, it is assumed that mother (user 5) serves as meal preparer X1 who prepares meals for all of the family members every day. Accordingly, mother (user 5) is the main person who needs to receive assistance for daily menu planning from menu assisting system 100. Of course, a family member (for example, father) other than mother may temporarily serve as meal preparer X1. In the present embodiment, as shown in FIG. 1, mother (user 5) owns (carries) presentation device 2.

As described above, presentation device 2 may be, for example, a portable information terminal such as a smart phone. Presentation device 2 is communicably connected to router 6 that is installed in house 200 when user 5 who is carrying presentation device 2 is in house 200. Presentation device 2 performs wireless communication that conforms to, for example, a standard such as Wi-Fi® with router 6. Router 6 may also be communicably connected to various types of home cooking appliances that are installed in house 200. The various types of home cooking appliances that are communicably connected to router 6 include a (electronic) microwave oven device, a freezer, a refrigerator, an oven, a rice cooker, and the like. Presentation device 2 is capable of performing wireless communication with the home cooking appliances via router 6. Also, when a home energy management system (HEMS) has already been installed in house 200, a controller of the HEMS is also communicably connected to router 6. Router 6 is connected to network NT1 such as the Internet (see FIG. 1). Presentation device 2 and the various types of home cooking appliances can perform communication with server 1 that is provided outside house 200 via router 6. Presentation device 2 is connected to network NT1 via a cellular network (carrier network) provided by a communication carrier, a public wireless LAN (Local Area Network), or the like when user 5 who is carrying presentation device 2 is outside house 200. Server 1 will be described in detail in the next section.

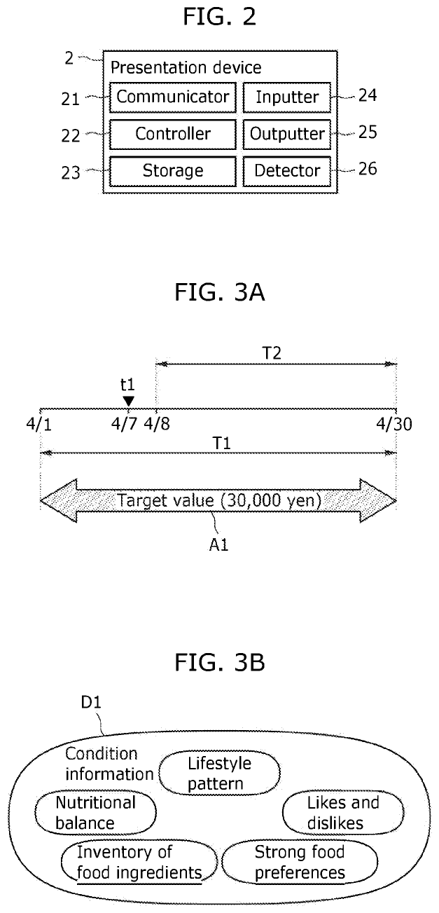

As shown in FIG. 2, presentation device 2 includes communicator 21, controller 22, storage 23, inputter 24, outputter 25, and detector 26. In presentation device 2, dedicated application software (hereinafter referred to simply as “menu recommendation application”) for performing communication with server 1 and home cooking appliances such as a microwave oven device and presenting a menu GUI (Graphical User Interface) is pre-installed.

Communicator 21 is a communication interface for performing communication with server 1 and home cooking appliances such as a microwave oven device. Presentation device 2 performs data transmission and reception with respect to server 1 and home cooking appliances such as a microwave oven device via communicator 21.

Controller 22 is configured to perform overall control of presentation device 2. Specifically, controller 22 is configured to control communicator 21, controller 22, storage 23, inputter 24, outputter 25, and detector 26. Controller 22 may be implemented by using, for example, a computer system that includes one or more processors (microprocessors) and one or more memories. That is, the one or more processors function as controller 22 by executing one or more programs (applications) stored in the one or more memories. Here, the programs are stored in the memory of controller 22 in advance, but may be provided by being transmitted through an electric communication line such as the Internet or by being recorded in a non-transitory recording medium such as a memory card.

Storage 23 is configured by using a read-write memory. Storage 23 is, for example, a flash memory. Storage 23 is provided outside controller 22, but may be provided within controller 22. That is, storage 23 may be an internal memory of controller 22. Storage 23 records various types of data items.

Inputter 24 is a user interface that receives an input operation from user 5. Here, a touch panel display (display 25A) that is attached to presentation device 2 also functions as inputter 24. In short, a user input is received as a result of user 5 performing an operation (a tapping operation or the like) on the display screen of display 25A by using a finger or the like. Also, a microphone that is attached to presentation device 2 may also function as inputter 24 (voice sound input). Inputter 24 receives a user input regarding the menu recommendation application.

In particular, inputter 24 receives an input of food ingredient information regarding food ingredients B2 personally acquired by user 5 (see FIG. 1). As used herein, the expression “food ingredients B2 personally acquired by user 5” refers to food ingredients that were purchased by user 5 at store 4 (see FIG. 1) such as a grocery store or were given by an acquaintance, a relative or the like, and does not refer to food ingredients B1 delivered by food ingredients delivery service provider 3. Also, inputter 24 receives a user input indicating an acceptance of the recommended menus or a user input indicating a cancellation of one of the recommended menus. Also, inputter 24 receives a user input indicating a change of the content of at least a portion of the recommended menus.

Outputter 25 is a user interface that outputs (presents) various types of information to user 5. Here, touch panel display 25A that is attached to presentation device 2 also functions as outputter 25. A speaker that is attached to presentation device 2 may also function as outputter 25. Outputter 25 outputs information regarding the menu recommendation application to user 5.

In particular, outputter 25 provides a menu recommendation by outputting, from display 25A, image data and character string data regarding menu information received from server 1, or outputting, from the speaker, voice sound data regarding the menu information.

Detector 26 is configured to detect the current location of user 5 who is carrying presentation device 2. Detector 26 acquires location information regarding the current location of presentation device 2 by using, for example, a satellite positioning system such as a GPS (Global Positioning System), and detects the current location of user 5 who is carrying presentation device 2 based on the acquired location information. Controller 22 transmits information regarding the current location of user 5 detected by detector 26 to server 1 via communicator 21.

By user 5 activating the menu recommendation application on presentation device 2 and inputting, on the log-in screen, a user ID and a password that have been assigned to user 5 by the menu provider, user 5 can receive various types of menu-related services associated with the user ID.

When user 5 activates the menu recommendation application on presentation device 2 and performs an input operation for making a request for a menu recommendation via inputter 24 at an arbitrary timing, presentation device 2 transmits a menu request signal that includes the user ID and the like to server 1. The input operation performed here is, for example, an input operation for designating target period T1 during which user 5 wants to receive menu recommendations. Accordingly, the transmitted menu request signal also includes information regarding target period T1 designated by user 5. If the user does not designate target period T1, the day on which the menu request signal was transmitted (one day) may be set as target period T1 by default. With the reception of the menu request signal from presentation device 2 being used as a trigger, server 1 performs menu recommendation processing by using AI (Artificial Intelligence) technology to recommend menus suitable for user 5 while keeping the food cost for target period T1 to be less than or equal to target value A1 (fixed charge 30,000 yen).

### (2.2) Server

Server 1 is installed outside house 200. Server 1 may be operated by, for example, the menu provider. As described above, as an example, server 1 is composed of one server device.

Server 1 records and manages various types of information from user 5 who receives menu information-related services via presentation device 2 or the like. Server 1 manages personal information (user ID, name, address, telephone number, email address information, and the like) of user 5. Also, server 1 manages identification information of presentation device 2, the user ID, and the password. Furthermore, server 1 manages location information of house 200, identification information of home cooking appliances installed in house 200, and the like. Family members (for example, father, children, and the like) other than mother may receive the services from menu assisting system 100 by installing the menu recommendation application on presentation devices 2 owned by the family members. In this case, group information indicating that the user IDs of the plurality of users 5 constitute one group (family) may be set and registered in server 1. A menu recommendation may be output to presentation device 2 of each user 5 on a family basis.

In particular, because a contract of the menu recommendation service that is a subscription service with a fixed monthly charge has been made between user 5 and the recommendation provider, server 1 also manages information regarding the content of the contract with user 5 in association with the user ID. Specifically, server 1 also manages information regarding the monthly food cost paid by user 5 and target period T1. In the contract, target period T1 may be automatically renewed, for example, on a monthly basis.

The information regarding user 5 described above is managed by server 1 as user data M2 (see FIG. 1). Server 1 also provides menu information providing service to users 5 other than house 200 (for example, other houses), and thus records and manages information regarding other users 5 as user data M2.

As shown in FIG. 1, server 1 includes communicator 10, controller C1, and storage 15.

Communicator 10 is a communication interface for performing interactive communication with presentation device 2 and home cooking appliances of user 5, as well as with an external server or an information terminal such as a smart phone operated by food ingredients delivery service provider 3, via network NT1. Communicator 10 corresponds to an acquirer that acquires food ingredient information regarding the food ingredients personally acquired by the user.

Storage 15 is configured by using a read-write memory. Storage 15 is, for example, a flash memory. Storage 15 is provided outside controller C1, but may be provided within controller C1. That is, storage 15 may be an internal memory of controller C1. Storage 15 records various types of data items. In particular, as shown in FIG. 1, storage 15 records (stores) food/beverage data M1 and user data M2.

Controller C1 is configured to perform overall control processing of server 1. Controller C1 may be implemented by using, for example, a computer system that includes one or more processors (microprocessors) and one or more memories. That is, the one or more processors function as controller C1 by executing one or more programs (applications) stored in the one or more memories. Here, the programs are stored in the memory of controller C1 in advance, but may be provided by being transmitted through an electric communication line such as the Internet or by being recorded in a non-transitory recording medium such as a memory card.

As shown in FIG. 1, controller C1 includes processing unit 11, evaluator 12, condition setter 13, and trainer 14. In other words, controller C1 has the function of processing unit 11, the function of evaluator 12, the function of condition setter 13, and the function of trainer 14.

Evaluator 12 is configured to evaluate (process) menus based on target value A1 of the food cost for target period T1. Here, basically, it is assumed that the timing at which the evaluation processing is performed is a timing at which a menu request signal is received from presentation device 2. However, there is no particular limitation on the timing at which the evaluation processing is performed, and evaluator 12 may be configured to automatically evaluate menus for all subscribing users 5 at a regular interval (for example, at twelve midnight every day), and store the evaluation results in storage 15 as user data M2 in association with users 5.

When evaluator 12 receives a menu request signal from presentation device 2, evaluator 12 determines target period T1 (here, from April 1 to 30) based on the menu request signal. As described above, a contract of the menu recommendation service that is a subscription service with a fixed monthly charge has been made between user 5 and the recommendation provider, and a period of one month is set as target period T1 based on the contract. When the menu request signal is received prior to the start of target period T1 (April 1 to 30) (for example, when the menu request signal is received on March, 30), evaluator 12 evaluates menus for entire target period T1, which is the period of the contract as an initial recommendation. Here, evaluator 12 extracts, based on the user ID included in the menu request signal, information regarding the monthly food cost (here, 30,000 yen) of user 5 with the user ID from user data M2 stored in storage 15, and sets the monthly food cost as target value A1.

Evaluator 12 determines a menu for each meal for every day for 30 days from April 1 to 30 while satisfying a condition (hereinafter referred to as “target condition”) that the food cost of recommended menus does not exceed target value A1 for target period T1. For example, evaluator 12 performs the following calculation: target value A1 (30,000 yen)÷the number of days in target period T1 (30 days), and determines menus such that the food cost per day is within about 1,000 yen. Evaluator 12 may recommend menus for all three meals including breakfast, lunch and dinner, or only menus for dinner according to the content of the contract with user 5.

Evaluator 12 determines menus based on food/beverage data M1 such that the food cost per day is within about 1,000 yen. Note that the food cost per day does not necessarily need to be within 1,000 yen that is the average value of the total number of days. With designation of user 5 through presentation device 2, adjustment may be made such that menus with a food cost of within 850 yen that is slightly lower than the average value are set for each weekday, and menus with a food cost of within 1,200 yen that is slightly higher than the average value are set for each of Saturdays, Sundays, and holidays (or special days).

Trainer 14 performs clustering or the like by analyzing the structures and features of the history information of users 5, and generates a machine learning model for each user 5 (or for each group such as for each family). The generated model is stored in storage 15 as user data M2 in association with the user ID. Evaluator 12 generates a menu plan that more suits the lifestyle pattern and the likes and dislikes of user 5 by also taking into consideration the model generated by trainer 14. Examples of the features of the history information may include a feature that user 5 is concerned about the weight or blood pressure and is therefore highly likely to accept low-calorie menus and low-salt menus, a feature that user 5 is highly likely to accept light meals for dinner on Saturdays, and the like.

Condition setter 13 is configured to set condition information D1. Evaluator 12 determines menus based on condition information D1 set by condition setter 13 while satisfying the target condition. Condition information D1 used herein includes, as shown in FIG. 3B, information regarding lifestyle pattern (lifestyle habits and lifestyle rhythm) of user 5, likes and dislikes of user 5, nutritional balance, inventory of food ingredients, strong food preferences of user 5, and the like. Also, condition information D1 includes information regarding a change or cancellation of a menu received from user 5 (described later) and calendar information of user 5.

The information regarding lifestyle pattern and likes and dislikes is information that is based on the features extracted by trainer 14 from the actual usage record of user 5 in the past (for example, the last month or the month before the last month) in the case where user 5 is continuously using menu assisting system 100. The information regarding lifestyle pattern and likes and dislikes is also linked to the model generated by trainer 14.

The information regarding nutritional balance is information for recommending a well-balanced ratio of staple food (rice and bread), side dish (vegetables, mushrooms, potatoes, and seaweed), main dish (meat, fish, eggs, and soy bean), milk, dairy products, fruits, and the like according to the gender and age of user 5. Evaluator 12 evaluates menus by taking nutritional balance into consideration.

The information regarding inventory of food ingredients is information that is linked to the inventory of food ingredients managed by food ingredients delivery service provider 3. Server 1 receives the information (inventory information) regarding inventory of food ingredients managed by food ingredients delivery service provider 3 from an external server (or an information terminal) operated by food ingredients delivery service provider 3 via network NT1, and stores the received inventory information in storage 15 as food/beverage data M1. Each time fresh food ingredients shipped from producers (for example, farmers, and the like) of the food ingredients arrive at food ingredients delivery service provider 3, shipment arrival information is transmitted to server 1, and server 1 updates food/beverage data M1 stored in storage 15. Evaluator 12 evaluates menus by taking into consideration the inventory information. When seasonal food ingredients during target period T1 are shipped and arrive at food ingredients delivery service provider 3, evaluator 12 may preferentially determine menus that use the seasonal food ingredients.

The inventory information also includes, not only information regarding inventory of food ingredients stocked in food ingredients delivery service provider 3, but also information regarding inventory of food ingredients stocked in house 200 (a freezer, a refrigerator, and the like) of user 5. In other words, server 1 also stores information regarding inventory of food ingredients delivered to user 5 by food ingredients delivery service provider 3 or the like in storage 15 as user data M2.

Evaluator 12 performs evaluation by taking into consideration management deadlines of food ingredients. The term “management deadline” used herein may be, for example, an expiration date (or a best-before date), but may be a time limit arbitrarily set by user 5 or food ingredients delivery service provider 3 (for example, a time limit set prior to the expiration date, or the like). As described above, server 1 manages the inventory of food ingredients stocked by food ingredients delivery service provider 3 and the inventory of food ingredients stocked by user 5, and evaluator 12 evaluates menus with recipes that preferentially use food ingredients whose expiration dates are approaching.

Food/beverage data M1 includes, in addition to the inventory information regarding inventory of food ingredients stocked in food ingredients delivery service provider 3, master information regarding cooking menus and recipes. When server 1 acquires information regarding new cooking menus and recipes posted by an external server or an individual, server 1 updates food/beverage data M1.

Furthermore, food/beverage data M1 includes not only information regarding cooking menus and recipes that are used by user 5 when cooking at home, but also information regarding dining-out (or prepared meals). Server 1 is cooperatively working with an external server that manages overall dining-out information such as restaurant information, reservation information, coupon information, and the like of a plurality of food-serving facilities including restaurant 7 (see FIG. 1) and provides various services. Server 1 also stores the dining-out information in storage 15 as food/beverage data M1.

The information regarding strong food preferences of user 5 is information that is input by user 5 through presentation device 2 as appropriate. The information regarding strong food preferences includes information indicating food likes and dislikes, information indicating a nutrition improvement goal set under consideration of calories, salt content, sugar content, and the like, and information indicating family members including children and elderlies. Evaluator 12 evaluates menus by taking into consideration strong food preferences of user 5.

Processing unit 11 is configured to perform predetermined processing based on the result of evaluation performed by evaluator 12. The predetermined processing as used herein includes, as basic processing, processing of transmitting information (menus) based on the result of evaluation performed by evaluator 12 to an information terminal (presentation device 2 of user 5) to present the information (menus). The predetermined processing also includes processing of storing the result of evaluation performed by evaluator 12, or in other words, “recommendation history” in storage 15 as user data M2 in association with the user ID.

Processing unit 11 generates a signal (menu presentation signal) that includes menu information (text information and image information regarding cooking menus and recipes) regarding the menus determined by evaluator 12, and transmits the generated signal to presentation device 2 of user 5 who transmitted a menu request signal via communicator 10. Processing unit 11 transmits the menu presentation signal to presentation device 2, and causes outputter 25 of presentation device 2 to output the menu information. However, there may be a family that does not want menu recommendations for more than a week ahead when target period T1 is a relatively long period such as one month (April 1 to 30). Processing unit 11 may store the result (menus) of evaluation performed by evaluator 12 for target period T1 in storage 15, and transmit the menus in a dispensed manner such as menus for one week or menus for 10 days together with the menu presentation signal to presentation device 2 so as to present the menus.

When communicator 21 of presentation device 2 receives the menu presentation signal, controller 22 displays the menu information on the display screen of display 25A that functions as outputter 25. The menu information is displayed for each meal such as breakfast, lunch, and dinner on a daily basis (or on a regular basis such as every Monday) on the display screen of display 25A together with cooking menus thereof and the total food cost required for the cooking menus. When user 5 performs a tapping operation or the like on a menu display region or a menu image region where the name of a menu is displayed, more detailed information (information regarding the names and quantities of food ingredients required to cook the menu, the cost of the food ingredients, cooking methods (information indicating what home cooking appliance should be used, and the like), and information regarding salt content and calories) may be displayed.

For example, when user 5 inputs, to inputter 24, an input operation to indicate an acceptance of the menus recommended for seven days from April 1 to 7 from among the menus recommended for target period T1 (April 1 to 30), presentation device 2 generates a menu acceptance signal that includes the result (the acceptance of the menus) and transmits the generated menu acceptance signal to server 1. In this case, presentation device 2 incorporates information indicating that the menus recommended for April 8 to 30 are kept on hold (neither accepted nor rejected) into the menu acceptance signal.

When server 1 receives the menu acceptance signal, processing unit 11 stores the acceptance/rejection history (actual usage record) of the recommended menus that were accepted/rejected by user 5 in storage 15 as user data M2 in association with the user ID. Furthermore, processing unit 11 performs request processing of making a request to deliver food ingredients B1 required for the accepted menus. In other words, when menu assisting system 100 receives a user input indicating an acceptance of recommended menus, menu assisting system 100 performs request processing of making a request to deliver food ingredients B1 required for the menus. Specifically, processing unit 11 transmits, to an external server (or an information terminal) operated by food ingredients delivery service provider 3, a delivery request signal that includes information (names, quantities, and the like) regarding food ingredients B1 used to cook the menus accepted by user 5 and the delivery destination (the name, address, telephone number, and the like of user 5). The menu provider pays, on behalf of user 5, the cost of food ingredients B1 to be delivered to food ingredients delivery service provider 3 from a fixed charge of 30,000 yen, which was paid from user 5 (proxy payment).

Then, food ingredients delivery service provider 3 delivers food ingredients B1 to the delivery destination designated by the deliver request signal received from server 1. Food ingredients B1 are preferably delivered by April 1 at the latest (in time for cooking).

The menu recommendation system (server 1) can receive, through inputter 24 of presentation device 2, a user input indicating a change of content of at least a portion of the recommended menus (or each recipe). The menu recommendation system (server 1) can also receive, through inputter 24 of presentation device 2, a user input indicating a request to cancel menus for one to several days or a menu for one meal of one day for some reasons (not at home due to a business trip, traveling, dining out, or the like).

Presentation device 2 also transmits information regarding a change or cancellation as described above to server 1 by incorporating the information into the menu acceptance signal. Server 1 also stores the information regarding a change or cancellation in user data M2 stored in storage 15 as the acceptance/rejection history (actual usage record) of user 5.

Presentation device 2 preferably outputs, from outputter 25, a message (in the form of character string data or voice sound data) that prompts user 5 to perform an input operation for, for example, accepting, changing, or cancelling with respect to the recommended menus.

Furthermore, the menu recommendation system (server 1) can also receive, through inputter 24 of presentation device 2, a user input indicating a request to reconsider all recommended menus. When server 1 receives a signal indicating a request to reconsider all recommended menus from presentation device 2, server 1 causes evaluator 12 to create menus whose content is different from that of the initially recommended menus, and causes presentation device 2 to again display the created menus.

Here, when evaluator 12 receives the user input indicating a request to change at least a portion of the content of the recommended menus, evaluator 12 determines whether the content of the menus after the change satisfies target value A1 and the nutritional balance of food ingredients. For example, in the case where a user input indicating a request to change a cooking menu (A) for dinner for one day to a cooking menu (B) is received, it may be difficult to satisfy the target condition due to a high food ingredient cost of the cooking menu (B). Alternatively, in the case where the cooking menu (B) that replaces the cooking menu (A) is the same as the menu for dinner several days before, the nutritional balance may be unbalanced. If the menu recommendation system (server 1) determines that the content of the menus after the change does not satisfy target value A1 and the nutritional balance, the menu recommendation system (server 1) creates different menus that satisfy target value A1 and the nutritional balance (for example, by making a small change to the food ingredients used for the cooking menu (B), or the like), and re-recommends the menus. The menu recommendation system (server 1) includes a notifier (corresponding to communicator 10 in this case) that issues a notification of the result of evaluation performed by evaluator 12. Then, the menu recommendation system (server 1) causes presentation device 2 to provide, via communicator 10 (notifier), an alert indicating that the menus to which the user changed are unlikely to satisfy target value A1 and the nutritional balance, and present re-recommended menus. In other words, the predetermined processing further includes processing of re-recommending menus that satisfy target value A1 and the nutritional balance if it is determined that the content of the menus after the change does not satisfy target value A1 and the nutritional balance.

In the example given above, a case was described where a change is made for each cooking menu, but a change may be made for each recipe in cooking menus. For example, a food ingredient (C) to be used in the cooking menu (A) may be changed to a food ingredient (D) that was produced from a production place different from that of the food ingredient (C), or the food ingredient (C) may be changed to a food ingredient (E) that was organically grown.

There may be a case where user 5 rejects one of the recommended menus. For example, in the case where user 5 has a plan to dine out on April 3, it is unnecessary to deliver the food ingredients required for the menus for that day. Accordingly, user 5 performs an input operation to cancel (reject) the menus for April 3 when user 5 receives the recommendation (for example, on March 30).

The initial recommendation is highly likely to be made prior to the start of target period T1, and thus, at this time, the recommendation history of menus recommended to user 5 for target period T1 and the acceptance/rejection history (actual usage record) of the recommended menus that were accepted/rejected by user 5 do not exist. Accordingly, as the initial recommendation, evaluator 12 determines menus without using the history information for target period T1 (the history used here is different from the above-described actual usage record history prior to target period T1 such as the history for the last month or the history for the month before the last month).

Next, the in-period recommendation will be described. Evaluator 12 is configured to (re)evaluate menus at arbitrary timing t1 in target period T1 (see FIG. 3A). Then, evaluator 12 performs evaluation based on the first information regarding the content of the recommended menus (recommendation history) and the second information regarding the actual usage record of the recommended menus during a period from the start of target period T1 to timing t1. That is, unlike the initial recommendation, the evaluation is performed at an arbitrary timing in target period T1, and thus the history information (the first information and the second information) during the period from the start of target period T1 to timing t1 exists. Here, the second information is information regarding the actual usage record of each recipe in the recommended menus (specifically, the actual usage record of each food ingredient in the cooking menus).

For example, as shown in FIG. 3A, it is assumed that user 5 performs an input operation to make a request for a menu recommendation through inputter 24 of presentation device 2 on April 7 (timing t1) (it is assumed that the menus on April 7 have already been accepted). Then, evaluator 12 of server 1 re-evaluates menus on and after April 8 based on the first information and the second information obtained during the period from the start of target period T1 to timing t1, in addition to condition information D1 that was described in the description of the initial recommendation.

In other words, evaluator 12 performs evaluation based on condition information D1 that includes information regarding at least one (both in this case) of the nutritional balance of food ingredients and the likes and dislikes of the user, in addition to the first information and the second information. Accordingly, the content of the recommended menus can be further improved. Also, evaluator 12 performs evaluation based on the management expiration dates of food ingredients, in addition to the first information and the second information. Accordingly, the content of the recommended menus can be improved while preventing food ingredients from exceeding their management expiration dates.

Specifically, evaluator 12 calculates the food cost for a period from April 1 to 7 based on the second information for the period, subtracts the calculated food cost from 30,000 yen that is the fixed charge (target value A1), and re-evaluates (re-calculates) menus for a period after timing t1 based on the remainder of the food cost.

A simple example will be described here. It is assumed that the menu recommendation system (server 1) recommends menus for seven days from April 1 to 7 with a food cost per day of 1,000 yen, and user 5 accepts the recommended menus for seven days as-is. Evaluator 12 re-evaluates menus for remaining period T2 (see FIG. 3A) that starts from April 8 based on the following calculation: 30,000-1,000×7=23,000 yen (the remainder of the food cost). That is, evaluator 12 re-evaluates menus such that the menus are more suited to the situation at timing t1, as compared with the menus for April 8 to 30 in the recommendation history determined and stored in storage 15 when the initial recommendation was made.

However, actually, it may not work out as in the simple example described above. The food cost per day of the recommended menus does not always need to be 1,000 yen, and may be 950 yen or 1,050 yen as long as the recommended menus satisfy the target condition. Also, user 5 may cancel one of the recommended menus for April 1 to 7. For example, when user 5 has a plan to dine out on April 3, user 5 may cancel (reject) the menus for April 3 from among the recommended menus for April 1 to 7, and accept only the menus for six days from April 1 to 7 excluding April 3 at a timing (for example, on March 30) at which user 5 receives the recommendation.

At arbitrary timing t1, processing unit 11 assumes, based on the difference between the first information (recommendation history) and the second information (acceptance/rejection history), that user 5 dines out (or eats a prepared meal) on that day as long as a cancellation of the menus for that day has been received. Then, processing unit 11 carries over the food cost (for example, 1,000 yen) of the cancelled menus to the food cost of the menus for remaining period T2 after timing t1. Then, evaluator 12 re-evaluates menus for remaining period T2 after timing t1 based on the following calculation: 23,000+1,000=24,000 yen (the remainder of the food cost). As a result, due to the cancellation of the menus, the menus for remaining period T2 after timing t1 may be changed to cooking menus that are a little more luxurious than the menus included in the initial recommendation by changing some of the food ingredients to those of the same type but higher quality (more luxurious).

In other words, the predetermined processing performed by processing unit 11 includes processing of giving a reward according to the difference between the first information and the second information. The reward used in this case refers to the carryover of the difference (the food cost of the cancelled menus) to the food cost of the menus for remaining period T2 after timing t1. The food cost of the cancelled menus may be carried over to the food cost of the next month (for example, May) instead of within the month (target period T1).

Alternatively, the reward may be given to user 5 by, instead of carrying over the difference (the food cost of the cancelled menus), giving reward points that correspond to the difference (the food cost of the cancelled menus) as a point return. When the reward points are accumulated to a predetermined amount, the reward points may be exchanged for a reward item(s) selected from a reward catalog issued by the menu provider, or may be exchanged, as one of the reward items, for a coupon ticket or a discount ticket that corresponds to, for example, the difference (the food cost of the cancelled menus) and is usable in restaurant 7 (see FIG. 1). The coupon ticket or the discount ticket may be a paper ticket that can be sent by mail, or may be managed as data and used as a result of user 5 inputting, on presentation device 2, a request to use the coupon ticket at restaurant 7 and then server 1 transmitting coupon ticket usage information to a terminal that is installed in restaurant 7.

In the case where a reward is given according to the difference (in particular, in the case where a reward is given by upgrading the quality of food ingredients), the menu recommendation system (server 1) causes presentation device 2 to transmit a notification to user 5. Also, the menu recommendation system (server 1) is configured such that user 5 can select whether to receive the reward in the form of carryover or point return by inputting a user input from presentation device 2.

In the case where the reward is given in the form of point return, the menu recommendation system (server 1) may provide a recommendation to dine out at food-serving facility where the reward points can be used, such as restaurant 7, at some point during remaining period T2 after timing t1 (for example, on Sunday or the like). As described above, detector 26 included in presentation device 2 detects the current location of user 5 by using a GPS or the like, and transmits information regarding the result of detection to server 1. Accordingly, if user 5 is moving near a store, a restaurant, or the like where the reward points given to user 5 can be used, server 1 may transmit, for example, a push notification including information regarding the store, the restaurant, or the like.

As described above, in the case where a difference occurs between the first information and the second information, a reward is given to user 5, and thus the service provided to user 5 can be improved.

Server 1 according to the present embodiment is configured to make a dining-out recommendation at an appropriate timing according to the likes and dislikes of user 5, a user input, or the like, irrespective of whether the reward is given in the form of point return. For example, when server 1 receives a user input indicating a cancelation with respect to the recommended menus, server 1 performs processing of making a dining-out recommendation. Server 1 also manages calendar information of user 5. For example, when information indicating that April 20 is a special day such as wedding anniversary is registered in advance through presentation device 2, server 1 makes a dining-out recommendation to dine out on that special day. If user 5 accepts the dining-out recommendation, a reward is given to user 5 in the manner described above. In this case, user 5 can select not only cooking but also dining out, and thus the usability is improved. Also, server 1 and food-serving facilities that provide dining-out services are more likely to cooperatively work with each other.

Also, user 5 may purchase food ingredients B2 at store 4 or receive food ingredients B2 from an acquaintance, a relative or the like, separately from delivered food ingredients B1. To address this, server 1 according to the present embodiment is configured to be capable of receiving, through presentation device 2, a registration of food ingredients B2 acquired separately from delivered food ingredients B1. When user 5 inputs, using inputter 24 of presentation device 2, food ingredient information that includes the names, quantities, acquisition date (for example, purchase date), expiration date, cost (in the case where user 5 purchased the food ingredients), and the like of acquired food ingredients B2, presentation device 2 transmits the food ingredient information to server 1. In the case where a one-dimensional code or a two-dimensional code is attached to a packaging material or the like that packages each of purchased food ingredients B2, presentation device 2 may read the code by using an image capturer (camera or the like) that is included in presentation device 2, and transmit the food ingredient information to server 1. Server 1 stores the food ingredient information regarding food ingredients B2 in the inventory information of user 5 stored as user data M2 described above.

In the present embodiment, the food ingredient information regarding food ingredients B2 is also included in the second information regarding the actual usage record of the recommended menus. When server 1 acquires the food ingredient information through communicator 10, server 1 subtracts a cost that corresponds to the food ingredient information from the food cost (target value A1), and recommends menus that use food ingredients B2. Specifically, evaluator 12 estimates food ingredient cost based on the acquired food ingredient information (uses the food ingredient cost input by the user in the case where the user purchased the food ingredients), subtracts the estimated food ingredient cost from the food cost of the menus for a period after timing t1 to obtain a remainder, and re-evaluates menus based on the remainder. In particular, evaluator 12 recommends menus that preferentially use food ingredients B2 by taking into consideration the expiration dates of food ingredients B2. When food ingredients B2 are used as the food ingredients of the recommended menus, processing unit 11 causes presentation device 2 to display the menus such that user 5 can easily and visually recognize that the menus use food ingredients B2. When user 5 accepts the menus that use food ingredients B2, processing unit 11 transmits, to an external server (or an information terminal) operated by food ingredients delivery service provider 3, a deliver request signal that includes information regarding food ingredients other than food ingredients B2. In this case, the menus that use food ingredients B2 are also recommended, and it is therefore possible to avoid the waste of food ingredients B2 while strictly sticking to target value A1 for target period T1.

Also, a situation may occur in which, despite the fact that user 5 accepted the recommended menus and food ingredients B1 were actually delivered, user 5 dined out or ate a prepared meal due to an unexpected event that happened after that, and thus did not cook the menu for a meal for one day (actual usage record). Server 1 according to the present embodiment is configured to receive a “cancellation after acceptance” at arbitrary timing t1 in target period T1 through a user input on presentation device 2. In this case, food ingredients B1 required for the menus on a day for which a cancellation after acceptance has been requested are still stored in the house of user 5 without being consumed. Accordingly, when server 1 receives information regarding the cancellation after acceptance, server 1 corrects the inventory information of user 5 in user data M2. Furthermore, server 1 re-evaluates menus for a period after timing t1 so as to preferentially use food ingredients B1 that are left unconsumed due to an unexpected event by taking into consideration the expiration dates of food ingredients B1. Also, in this case, when information that proves dining-out (information regarding a receipt issued by restaurant 7, or the like) is transmitted to server 1, a reward that corresponds to the food ingredient cost of the menus that were cancelled after acceptance of the menus may be given to user 5.

When a user input indicating a change of content of at least a portion of the recommended menus is received at arbitrary timing t1 in target period T1, evaluator 12 determines whether the content of the menus after the change satisfies target value A1 and the nutritional balance of food ingredients. This change corresponds to a “change before acceptance”, and is a change to menus that have not yet been accepted and thus are kept on hold, or in other words, menus for which food ingredients required have not yet been delivered (purchased). If it is determined that the content of the menus after the change does not satisfy target value A1 and the nutritional balance, server 1 causes outputter 25 of presentation device 2 to provide an alert (notification) indicating the fact. Furthermore, server 1 creates and re-recommends different menus for remaining period T2 after timing t1 that satisfy target value A1 and the nutritional balance of food ingredients. The re-recommended menus are presented from outputter 25 of presentation device 2. In other words, the predetermined processing further includes processing of re-recommending menus for remaining period T2 after timing t1 that satisfy target value A1 and the nutritional balance when it is determined that the content of the menus after the change does not satisfy target value A1 and the nutritional balance.

Furthermore, a situation may occur in which, despite the fact that user 5 accepted the recommended menus and food ingredients B1 were actually delivered, user 5 changed the cooking menu (A) for a meal for one day to the cooking menu (B) due to an unexpected event (actual usage record). Server 1 according to the present embodiment is configured to receive a “change after acceptance” at arbitrary timing t1 in target period T1 through a user input on presentation device 2. In this case, it is highly likely that, at timing t1, the food ingredients that are actually stored in the house of user 5 are different from the inventory information of user 5 that is managed on server 1 side. Accordingly, when server 1 receives information regarding a change after acceptance, server 1 corrects the inventory information of user 5 in user data M2, and re-evaluates menus for a period after timing t1 by taking into consideration the expiration dates of food ingredients B1.

As described above, in the present embodiment, at arbitrary timing t1 in target period T1, menus are re-evaluated based on the first information and the second information, and the content of the menus for remaining period T2 after timing t1 is changed. In other words, the predetermined processing performed by processing unit 11 includes processing of changing the content of the menus for remaining period T2 after timing t1 in target period T1.

In the case where the contract start date is in the middle of a month, only for that month, a period from the contract start date to the end of the month is set as target period T1. An initial recommendation is made several days before the contract start date, and food cost for the period from the contract start date to the end of the month is set as target value A1.

Arbitrary timing t1 in target period T1 described above is a timing at which an input operation to make a request for recommending, changing, or cancelling menus is received from user 5 through inputter 24 of presentation device 2. That is, timing t1 is dependent on the active action of user 5. However, timing t1 may be passive for user 5. Server 1 according to the present embodiment is configured to, when information indicating that the actual cost price of a specific food ingredient has varied is received, re-recommend menus that use food ingredients that have not yet been purchased by the user.

For example, even for food ingredients (farm products) of the same type, the prices may fluctuate depending on whether the harvest is good or bad. When server 1 acquires information regarding a fluctuation in the price of a food ingredient from food ingredients delivery service provider 3, evaluator 12 re-evaluates menus that have been recommended to user 5 but have not yet been accepted by user 5 and are kept on hold. Specifically, in the recommended menus, if there is a specific food ingredient whose price has risen sharply due to a bad harvest caused by continuous rainy days, evaluator 12 creates menus that do not use the food ingredient. Conversely, if there is a specific food ingredient whose price has fallen due to a good harvest, evaluator 12 creates menus that use the food ingredient. Then, processing unit 11 transmits a push notification or the like indicating that the menus have been re-evaluated according to the fluctuation in the price of the food ingredient to presentation device 2. Accordingly, it is possible to make a better menu recommendation according to the fluctuation in the price of the food ingredient.

When the price of a specific food ingredient decreases, a reward corresponding to the price difference may be given to user 5 in the form of point return.

### (2.3) Description of Operations

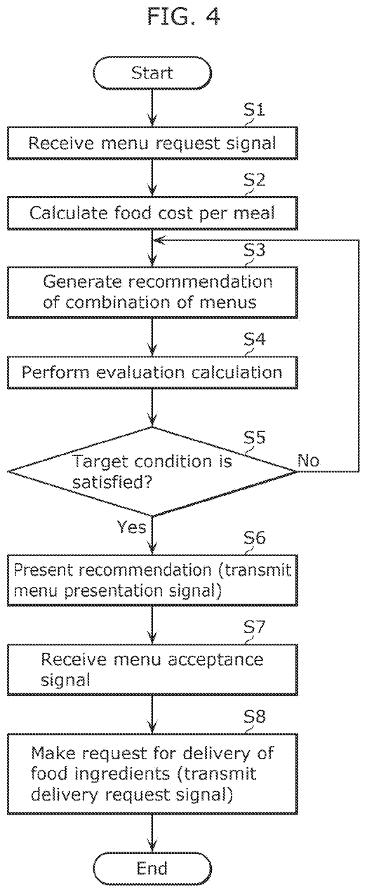

Hereinafter, operations performed by menu assisting system 100 according to the present embodiment will be roughly described with reference to FIG. 4. In the description of operations given below, the order in which the operations are performed is merely an example, and therefore the present disclosure is not limited thereto. Also, in the following description, an example will be described in which a request for a menu recommendation is made at arbitrary timing t1 in target period T1.

In house 200, user 5 who is meal preparer X1 activates the menu recommendation application on presentation device 2, and logs into the menu recommendation application by inputting the user ID and the password of user 5. Furthermore, user 5 performs an input operation to make a request for recommending menus through the menu recommendation application. In response to the input operation from user 5, presentation device 2 transmits a menu request signal to server 1.

Server 1 receives the menu request signal (step S1). Server 1 evaluates menus at timing t1. Server 1 re-evaluates menus based on the first information (recommendation history) and the second information (acceptance/rejection history) that correspond to the user ID (evaluation step). That is, server 1 calculates the remainder of the food cost that corresponds to the user ID based on the first information and the second information at timing t1, and also calculates food cost per meal for the menus for a period after timing t1 (step S2). Then, server 1 generates a recommendation of combination of menus for a period after timing t1 based on condition information D1 and the (machine learning) model of user 5 by taking into consideration the food cost per meal (step S3).

Then, server 1 calculates the total food cost for target period T1 based on the recommendation of combination of menus that was generated (step S4: evaluation calculation). Server 1 generates a recommendation of combination of menus and performs evaluation calculation until the target condition in which the total food cost for target period T1 including the food cost of the recommendation of combination of menus does not exceed target value A1 is satisfied (step S5). That is, if it is determined that the result of evaluation dost not satisfy the target condition (No in step S5), server 1 returns to step S3, and generates another recommendation of combination of menus.

If it is determined that the result of evaluation satisfies the target condition (Yes in step S5), server 1 causes presentation device 2 to recommend (display) the recommendation of combination of menus (step S6: processing step). That is, server 1 transmits a menu presentation signal to presentation device 2.

When presentation device 2 receives the menu presentation signal, presentation device 2 displays the recommended menus on display 25A. When user 5 performs an input operation to accept (or change, cancel, or the like) the recommended menus, presentation device 2 generates a menu acceptance signal and transmits the menu acceptance signal to server 1.

When server 1 receives the menu acceptance signal (step S7), server 1 transmits a delivery request to food ingredients delivery service provider 3 in response to receiving the menu acceptance signal (if there are accepted menus) (step S8). That is, server 1 generates a delivery request signal and transmits the delivery request signal to a terminal that is provided in food ingredients delivery service provider 3.

As described above, with server 1 (menu recommendation system) according to the present embodiment, menu (re)evaluation at arbitrary timing t1 is performed based on the menus (recommendation history) recommended until timing t1 and the actual usage record of the menus (acceptance/rejection history). Then, predetermined processing (of making a recommendation) is performed based on the result of (re)evaluation. Accordingly, it is possible to recommend updated menus that reflect, in addition to the elements (the remainder of the food cost, and the like) that vary on a daily basis, the past recommendation history and the acceptance/rejection history in target period T1. As a result, it is possible to provide an advantage in that the content of the recommended menus can be improved.

In particular, it may be a heavy burden for meal preparer X1 (user 5) to plan a daily menu and go shopping for food ingredients while taking into consideration various factors (the likes and dislikes of family members, nutritional balance, the expiration dates of food ingredients, and whether the menus are similar). However, by using the menu recommendation system according to the present embodiment, the burden on meal preparer X1 (user 5) can be reduced.

### (3) Variations

The embodiment described above is merely an example of various embodiments of the present disclosure. Various types of changes can be made to the embodiment given above according to the design and the like as long as the object of the present disclosure can be achieved. Also, functions that are similar to the functions of the menu recommendation system (server 1) according to the embodiment given above, presentation device 2, and menu assisting system 100 that includes server 1 and presentation device 2 may be implemented as an information presentation method, a computer program, or a non-transitory recording medium in which the computer program is recorded.

For example, the functions of presentation device 2 included in menu assisting system 100 may be implemented as a processing method performed by presentation device 2, a computer program, or a non-transitory recording medium in which the computer program is recorded. The processing method performed by presentation device 2 includes: acquiring an actual usage record of menus; transmitting the actual usage record to server 1; receiving evaluation result information from server 1; and outputting the evaluation result information. The functions of presentation device 2 may be implemented as a program that causes one or more processors of presentation device 2 to execute the above-described processing method.

Variations of the embodiment described above will be given below. The variations described below may be combined as appropriate. Hereinafter, the embodiment described above may be referred to as “basic example”.

Each of the menu recommendation system (server 1), presentation device 2, and menu assisting system 100 according to the present disclosure that includes server 1 and presentation device 2 includes a computer system. The computer system is composed mainly of a processor and a memory that are hardware. As a result of a program recorded in the memory of the computer system being executed by the processor, the functions of the menu recommendation system (server 1), presentation device 2, and menu assisting system 100 according to the present disclosure that includes server 1 and presentation device 2 are implemented. The program may be recorded in advance in the memory of the computer system, provided through an electric communication line, or provided by being recorded in a non-transitory recording medium, such as a memory card, an optical disk, or a hard disk drive, that can be read by the computer system. The processor of the computer system includes one or more electronic circuits including a semiconductor integrated circuit (IC) or a large-scale integrated circuit (LSI). The integrated circuit such as an IC or an LSI used herein may be called by different names according to the degree of integration. An integrated circuit called system LSI, VLSI (Very Large Scale Integration), or ULSI (Ultra Large Scale Integration) is included. Furthermore, an FPGA (Field-Programmable Gate Array) or a logic device that can be programmed after LSI production, the logic device being configured to enable reconfiguration of connections in the LSI or reconfiguration of circuit sections in the LSI can also be used as a processor. A plurality of electronic circuits may be aggregated into one chip, or may be provided by being dispersed in a plurality of chips. The plurality of chips may be aggregated into one device, or may be provided by being dispersed in a plurality of devices. The computer system used herein includes a micro controller that includes one or more processors and one or more memories. Accordingly, the micro controller is also composed of one or more electronic circuits including a semiconductor integrated circuit or a large-scale integrated circuit.

Also, the configuration in which a plurality of functions of the menu recommendation system are aggregated in one housing is not a requirement. For example, the structural elements of the menu recommendation system may be provided by being dispersed in a plurality housings. Conversely, the plurality of functions of the menu recommendation system may be aggregated in one housing. Furthermore, at least one of the functions of the menu recommendation system such as, for example, one of the functions of the menu recommendation system may be implemented by a cloud (cloud computing) or the like.

In the basic example, target value A1 of the food cost is set to a fixed charge of 30,000 yen. However, the menu recommendation system may be configured such that user 5 can change target value A1, for example, on a monthly basis. For example, target value A1 for April may be set to 30,000 yen, and target value A1 for May may be set to 40,000 yen. Also, target value A1 is not limited to the amount of money, and may be reward points or the like to which the amount of money is converted.

The basic example has been described based on the assumption that the menu recommendation system provides a subscription for a food ingredients delivery service, but the present disclosure is not specifically limited thereto. For example, when the menu recommendation system recommends menus for target period T1, user 5 may purchase all food ingredients required for the menus. In this case, user 5 pays only a usage fee for the menu recommendation system (excluding food ingredient cost) to the menu provider.

### (4) Examples

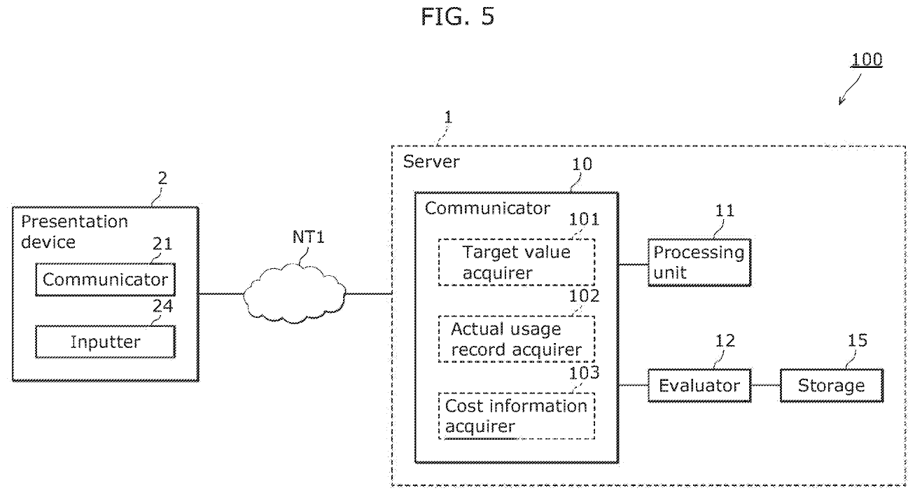

Examples 1 to 4 according to the embodiment described above will be given below. In the examples given below, a description of structural elements and the like that are the same in all examples will be omitted. First, structural elements that are the same in the examples will be described with reference to FIG. 5. FIG. 5 is a block configuration diagram of a menu recommendation system (server 1 in this example) used in Examples 1 to 4 of the embodiment. In FIG. 5, among the structural elements shown in FIG. 1, the structural elements that are not mentioned in Examples 1 to 4 are not shown. Also, in FIG. 5, presentation device 2 is connected directly to network NT1, but may be connected to network NT1 via router 6.

Server 1 includes communicator 10, processing unit 11, evaluator 12, and storage 15. Also, communicator 10 has the functions of target value acquirer 101, actual usage record acquirer 102, and cost information acquirer 103, which will be described below. The following description will be given on the assumption that, in Examples 1 to 4, at least a portion of the predetermined processing performed by processing unit 11 in the embodiment described above is performed by evaluator 12.

Target value acquirer 101 acquires target value A1 of the food cost for target period T1. In this example, target value acquirer 101 acquires target value A1 by performing communication with presentation device 2 of user 5 at the time when user 5 has made contract with the menu provider. Specifically, user 5 performs an input operation of setting target value A1 on inputter 24 of presentation device 2. Then, presentation device 2 transmits target value A1 received by inputter 24 to server 1 via communicator 21. Target value acquirer 101 thereby acquires target value A1. After that, target value acquirer 101 acquires target value A1 only when user 5 changes target value A1 until the contract between user 5 and the menu provider ends.

Actual usage record acquirer 102 acquires an actual usage record of menus recommended by evaluator 12 from user 5 at arbitrary timing t1 in target period T1. In this example, actual usage record acquirer 102 acquires the actual usage record by, for example, performing communication with presentation device 2 of user 5. Specifically, at arbitrary timing t1, user 5 performs an operation of inputting an actual usage record on inputter 24 of presentation device 2. Then, presentation device 2 transmits the actual usage record received by inputter 24 to server 1 via communicator 21. Actual usage record acquirer 102 thereby acquires the actual usage record.

The actual usage record includes an acceptance/rejection history of menus recommended by evaluator 12 that were accepted/rejected by user 5. Specifically, the actual usage record may include: an actual usage record in which recommended menus that were accepted by user 5 are recorded; an actual usage record in which recommended menus that were rejected (cancelled) by user 5 are recorded; and an actual usage record in which recommended menu that were accepted by user 5 after making a change (for example, changing some food ingredients) are recorded. The food ingredients that were changed may include food ingredients B2 personally acquired by user 5.

Cost information acquirer 103 acquires cost information regarding a food ingredient cost. Here, the cost information includes a predicted value of cost price of food ingredients. Specifically, cost information acquirer 103 acquires information via network NT such as, for example, the Internet, the information including: a past sales plan or a future sales plan for selling food ingredients made by food ingredients delivery service provider 3; past fluctuation information or future fluctuation information regarding fluctuations in retail prices at wholesale markets; weather information or weather forecast information of production places of food ingredients; past actual shipment records, shipment plans, or shipping forecast information of production places of food ingredients; and the like. Then, cost information acquirer 103 acquires a predicted value of cost price of food ingredients through calculation by comprehensively taking the acquired information into consideration. Cost information acquirer 103 may acquire a predicted value of cost price of food ingredients from a service provider that provides the predicted value of cost price of food ingredients.

Processing unit 11 presents the menus recommended by evaluator 12 to user 5. In this example, processing unit 11 transmits the menus recommended by evaluator 12 to presentation device 2 by, for example, performing communication with presentation device 2 of user 5. As a result, presentation device 2 outputs (presents) the menus recommended by evaluator 12. The menus recommended by evaluator 12 may include: menus initially recommended by an initial recommendation making function, which will be described later; and menus included in an in-period recommendation made by an in-period recommendation making function, which will be described later, or in other words, re-recommended menus recommended again in target period T1.

Evaluator 12 has an initial recommendation making function, an in-period recommendation making function, and a reward function. The initial recommendation making function is, in short, a function of making an initial recommendation by recommending menus for target period T1 at a timing prior to the start of target period T1 based on food/beverage data M1 recorded in storage 15 so as not to exceed target value A1 acquired by target value acquirer 101. In other words, with the initial recommendation making function, evaluator 12 recommends menus for target period T1 based on target value A1 acquired by target value acquirer 101.

The in-period recommendation making function is, in short, a function of making an in-period recommendation by re-recommending menus for remaining period T2 at arbitrary timing t1 in target period T1 based on the actual usage record acquired by actual usage record acquirer 102. Specifically, during a period from the start of target period T1 to timing t1, evaluator 12 compares first information regarding the content of the menus recommended by evaluator 12 (or in other words, initially recommended menus) with second information regarding the actual usage record acquired by actual usage record acquirer 102. Then, if a difference is found between the first information and the second information, evaluator 12 performs re-recommendation processing of re-recommending menus for remaining period T2 that is after timing t1 in target period T1 by changing the content of the recommended menus. The difference between the first information and the second information may occur when, for example, the user does not accept the recommended menus or when the user accepts the recommended menus by making a change to the recommended menus.

The reward function is a function based on the actual usage record acquired by actual usage record acquirer 102 at arbitrary timing t1 in target period T1, as with the in-period recommendation making function. With the reward function, unlike the in-period recommendation making function, evaluator 12 performs reward processing of giving a reward to user 5 according to the difference between the first information and the second information when the difference is found. The reward processing may be processing of carrying over the price difference to the food cost of the menus for the period after timing t1, or processing of giving reward points that correspond to the price difference as a point return.

Evaluator 12 may take local area information into consideration when recommending menus by using either one of the initial recommendation making function or the in-period recommendation making function. The local area information as used herein is information regarding a local area in which user 5 resides, and may include: information regarding food ingredients that are relatively often used in the local area; information regarding food ingredients that are produced only in the local area; information regarding menus that are relatively often accepted in the local area; and information regarding menus that are accepted only in the local area. In this case, menus that are unique to the local area in which user 5 resides are likely to be recommended or re-recommended to user 5. Accordingly, it is possible to easily provide a service that is suitable for the requests of user 5, and thus this configuration is preferable.

### (4.1) Example 1

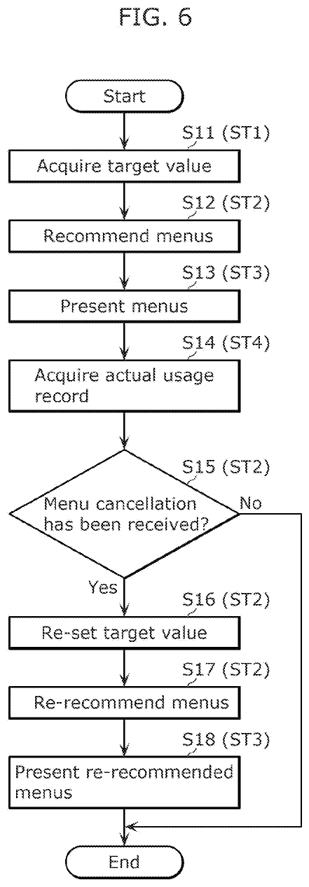

Example 1 according to the embodiment given above will be described below with reference to FIG. 6. FIG. 6 is a flowchart diagram illustrating operations performed in a menu recommendation system (server 1 in this example) according to Example 1 of the embodiment. Example 1 will be described based on the assumption that actual usage record acquirer 102 acquires an actual usage record indicating that user 5 cancelled one of the menus at arbitrary timing t1 in target period T1.

First, target value acquirer 101 acquires target value A1 for the food cost for target period T1 (S11). Processing S11 corresponds to target value acquiring step ST1 of the menu recommendation method. Next, evaluator 12 recommends, by using the initial recommendation making function, menus for target period T1 so as not to exceed target value A1 acquired by target value acquirer 101 (S12). Processing S12 corresponds to evaluation step ST2 of the menu recommendation method. Then, processing unit 11 presents initially recommended menus to user 5 by transmitting the menus recommended by evaluator 12 to presentation device 2 (S13). Processing S13 corresponds to processing step ST3 of the menu recommendation method.

After that, it is assumed that, at arbitrary timing t1 in target period T1, user 5 inputs an actual usage record of the menus recommended by evaluator 12 by operating presentation device 2. Then, actual usage record acquirer 102 acquires the actual usage record from user 5 at timing t1 (S14). Processing S14 corresponds to actual usage record acquiring step ST4 of the menu recommendation method.

Then, evaluator 12 compares first information regarding the content of the menus recommended by evaluator 12 during a period from the start of target period T1 to timing t1 with second information regarding the actual usage record acquired by actual usage record acquirer 102 during the period from the start of target period T1 to timing t1 (S15). As a result of the comparison, if it is determined that there is no difference between the first information and the second information (No in S15), evaluator 12 performs no processing. On the other hand, if it is determined that a difference has occurred between the first information and the second information due to cancellation of one of the menus (Yes in S15), evaluator 12 re-sets target value A1 such that the food cost of the cancelled menu is carried over to the food cost of the menus for remaining period T2 (S16). The, evaluator 12 re-recommends the menus for remaining period T2 after timing t1 so as not to exceed target value A1 that was re-set (S17). Processing operations S15, S16, and S17 correspond to evaluation step ST2 of the menu recommendation method. Then, processing unit 11 presents the menus re-recommended by evaluator 12 to user 5 by transmitting the re-recommended menus to presentation device 2 (S18). Processing S18 corresponds to processing step ST3 of the menu recommendation method.

As described above, in Example 1, evaluator 12 performs both the reward processing of carrying over the food cost of the cancelled menu to the food cost of the menus for remaining period T2 and the re-recommendation processing of re-recommending the menus for remaining period T2.

### (4.2) Example 2

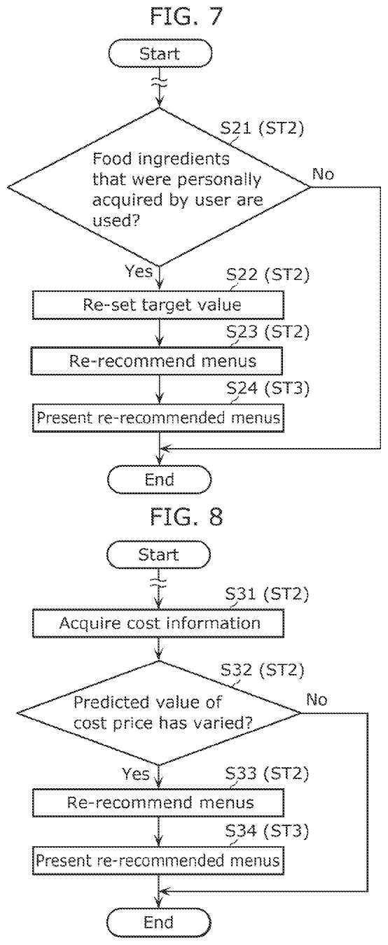

Example 2 according to the embodiment given above will be described below with reference to FIG. 7. FIG. 7 is a flowchart diagram illustrating operations performed in a menu recommendation system (server 1 in this example) according to Example 2 of the embodiment. Example 2 is different from Example 1 in that actual usage record acquirer 102 acquires, at arbitrary timing t1 in target period T1, an actual usage record indicating that food ingredients B2 personally acquired by user 5 were used in one of the menus. Processing operations S11 to S14 are the same as those of Example 1, and thus processing operations S11 to S14 are not shown in FIG. 7.

Evaluator 12 compares first information regarding the content of the menus recommended by evaluator 12 during the period from the start of target period T1 to timing t1 with second information regarding the actual usage record acquired by actual usage record acquirer 102 (S21). As a result of the comparison, if it is determined that there is no difference between the first information and the second information (No in S21), evaluator 12 performs no processing. On the other hand, if it is determined that a difference has occurred between the first information and the second information due to food ingredients B2 personally acquired by user 5 being used in one of the menus (Yes in S21), evaluator 12 re-sets target value A1 by subtracting the ingredient cost of food ingredients B2 from the food cost set for the menus for remaining period T2 (S22). Then, evaluator 12 re-recommends the menus for remaining period T2 after timing t1 so as not to exceed target value A1 that was re-set (S23). In this case, evaluator 12 re-recommends the menus for remaining period T2 so as to preferentially use food ingredients B2 personally acquired by user 5. Processing operations S21, S22, and S23 correspond to evaluation step ST2 of the menu recommendation method. Then, processing unit 11 presents the menus re-recommended by evaluator 12 to user 5 by transmitting the re-recommended menus to presentation device 2 (S24). Processing S24 corresponds to processing step ST3 of the menu recommendation method.

### (4.3) Example 3

Example 3 according to the embodiment given above will be described below with reference to FIG. 8. FIG. 8 is a flowchart diagram illustrating operations performed in a menu recommendation system (server 1 in this example) according to Example 3 of the embodiment. Example 3 is different from Examples 1 and 2 in that re-recommended menus are made based on the cost information acquired by cost information acquirer 103 instead of based on the actual usage record acquired by actual usage record acquirer 102. Processing operations S11 to S14 are the same as those of Example 1, and thus processing operations S11 to S14 are not shown in FIG. 8.

In target period T1, cost information acquirer 103 regularly acquires cost information (S31). Then, evaluator 12 monitors, based on the cost information acquired by cost information acquirer 103, whether the predicted value of cost price of food ingredients has varied at the time when food ingredients are delivered to user 5 (S32). The cost information acquired by cost information acquirer 103 may be information regarding all food ingredients that may be included in the menus recommended by evaluator 12, or may be information regarding only some specific food ingredients.

As a result of the monitoring, if it is determined that the predicted value of cost price of food ingredients has not varied, or in other words, the predicted value of cost price of food ingredients is within a reference range (No in S32), evaluator 12 performs no processing. On the other hand, if it is determined that the predicted value of cost price of food ingredients has varied, or in other words, the predicted value of cost price of food ingredient is outside the reference range (Yes in S32), evaluator 12 re-recommends menus that use food ingredients that have not yet been purchased by user 5 (S33). Processing operations S32 and S33 correspond to evaluation step ST2 of the menu recommendation method.

Specifically, if it is determined that the predicted value of cost price of food ingredients is higher than the reference range, evaluator 12 re-recommends menus to exclude the food ingredients. If it is determined that the predicted value of cost price of food ingredients is lower than the reference range, evaluator 12 re-recommends menus to include the food ingredients. In the latter case, evaluator 12 may perform reward processing of carrying over a price difference in the cost price of food ingredients to the food cost set for the menus for the remaining period when re-recommending the menus, or giving reward points that correspond to the price difference to user 5, or the like. Also, strong food preferences of user 5 may be taken into consideration. If the average value of the cost price of favorite food ingredients of user 5 is less than a predetermined price, evaluator 12 may re-recommend menus so as to preferentially include the favorite food ingredients of user 5 in the menus. Then, processing unit 11 presents the menus re-recommended by evaluator 12 to user 5 by transmitting the re-recommended menus to presentation device 2 (S34). Processing S34 corresponds to processing step ST3 of the menu recommendation method.

### (4.4) Example 4

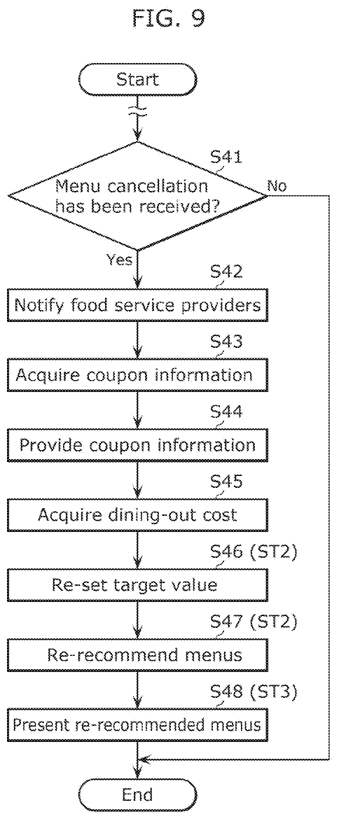

Example 4 according to the embodiment given above will be described below with reference to FIG. 9. FIG. 9 is a flowchart diagram illustrating operations performed in a menu recommendation system (server 1 in this example) according to Example 4 of the embodiment. Example 4 is different from Example 1 in that, when user 5 cancels one of the menus, first, dining-out information is presented to user 5. That is, in Example 4, when actual usage record acquirer 102 acquires a user input indicating a cancellation of one of the recommended menus, evaluator 12 performs processing of providing dining-out information that recommends dining out, or coupon information or discount information that can be used for dining out. Processing operations S11 to S14 are the same as those of Example 1, and thus processing operations S11 to S14 are not shown in FIG. 9.

Evaluator 12 compares first information regarding the content of the menus recommended by evaluator 12 during the period from the start of target period T1 to timing t1 with second information regarding the actual usage record acquired by actual usage record acquirer 102 (S41). As a result of the comparison, if it is determined that there is no difference between the first information and the second information (No in S41), evaluator 12 performs no processing. On the other hand, if it is determined that a difference has occurred between the first information and the second information due to cancellation of one of the menus (Yes in S41), evaluator 12 transmits a notification of date information regarding the date for which the menu was cancelled by user 5 to food service providers via communicator 10 and network NT1 (S42). The term “food service providers” as used herein may encompass, for example, food providers that provide food and beverages to users 5 such as restaurants, home delivery providers that deliver ready-to-eat meals, ready-to-eat dishes and the like to users 5, and the like.

Evaluator 12 acquires coupon information that can be used by user 5 on the date for which the menu was cancelled by user 5 from the food service providers via communicator 10 and network NT1 (S43). Then, evaluator 12 provides the acquired coupon information to user 5 through, for example, communication between processing unit 11 and presentation device 2 (S44). The coupon information may be provided directly to user 5 from the food service providers without using evaluator 12. In this case as well, coupon information is provided to user 5 in response to a notification of the date information being transmitted from evaluator 12 to the food service provider, and thus it can be said that evaluator 12 indirectly provides the coupon information to user 5.

As used herein, the coupon information is information that is presented by user 5 to a food service provider selected by user 5. When user 5 presents the coupon information to the selected food service provider, user 5 can enjoy a food/beverage providing service that provides food and beverages that correspond to the coupon information or a food/beverage discount service that discounts food and beverages that correspond to the coupon information. The food and beverages that correspond to the coupon information may include, for example, food and beverages with prices within a range that does not exceed target value A1, and food and beverages that are available with reward points accumulated by user 5. Also, it is preferable that the food and beverages that correspond to the coupon information do not include food and beverages that are the same as those included in the menus for several days before the day on which user 5 canceled the menu, and food and beverages that are in the same categories as those included in the menus for several days before the day on which user 5 canceled the menu. Furthermore, the food and beverages that correspond to the coupon information are preferably food and beverages that have a similar nutritional balance as those of the menu cancelled by user 5.

After that, evaluator 12 acquires dining-out cost consumed by user 5 via communicator 10 and network NT1 (S45). For example, evaluator 12 may acquire the dining-out cost by user 5 inputting the dining-out cost by operating presentation device 2, or may acquire the dining-out cost from a payment company such as the credit card company of a credit card used by user 5. Evaluator 12 re-sets target value A1 by subtracting the dining-out cost from the food cost of the menus for remaining period T2 (S46). Then, evaluator 12 re-recommends the menus for remaining period T2 after timing t1 so as not to exceed target value A1 that was re-set (S47). Processing operations S46 and S47 correspond to evaluation step ST2 of the menu recommendation method. Then, processing unit 11 presents the menus re-recommended by evaluator 12 to user 5 by transmitting the re-recommended menus to presentation device 2 (S48). Processing S48 corresponds to processing step ST3 of the menu recommendation method.

The menu recommendation system (server 1) may not include target value acquirer 101. In this case, evaluator 12 may recommend menus for target period T1 without using target value A1. For example, evaluator 12 may receive an input of family members of user 5 and/or their ages, and recommend menus for target period T1 according to the received input. Also, for example, evaluator 12 may receive an input of recipes from user 5 and recommend menus (including the received recipes) for target period T1 according to the received input.

### (5) Conclusion

As described above, a menu recommendation system (here, server 1) according to a first aspect recommends menus for a target period (T1) based on a target value (A1) of a food cost for the target period (T1). The menu recommendation system (server 1) includes an evaluator (12) and a processing unit (11). The evaluator (12) evaluates the menus at an arbitrary timing (t1) in the target period (T1). The processing unit (11) performs predetermined processing based on a result of the evaluation performed by the evaluator (12). The evaluator (12) performs the evaluation based on first information regarding the content of the recommended menus and second information regarding an actual usage record of the recommended menus during a period from the start of the target period (T1) to the arbitrary timing (t1). According to the first aspect, the content of the recommended menus can be improved.

A menu recommendation system (server 1) according to a second aspect is configured by changing the configuration of the first aspect such that the predetermined processing includes reward processing of giving a reward according to a difference between the first information and the second information. According to the second aspect, in the case where a difference occurs between the first information and the second information, the service provided to a user (5) can be improved.

A menu recommendation system (server 1) according to a third aspect is configured by changing the configuration of the first or second aspect such that the menu recommendation system according to the third aspect further includes an acquirer (communicator 10) that acquires food ingredient information regarding food ingredients (B2) personally acquired by the user (5). When the menu recommendation system (server 1) acquires the food ingredient information, the menu recommendation system (server 1) subtracts a cost that corresponds to the food ingredient information from the food cost and recommends menus that use the food ingredients (B2). According to the third aspect, it is possible to avoid the waste of the food ingredients (B2) while strictly sticking to the target value (A1) of the target period (T1).

A menu recommendation system (server 1) according to a fourth aspect is configured by changing the configuration of any one of the first to third aspects so as to perform processing of making a dining-out recommendation when a user input indicating a request to cancel one of the recommended menus is received. According to the fourth aspect, the user (5) can easily select not only cooking but also dining-out, and thus the usability is improved. Also, it is possible to easily enable cooperation between the menu recommendation system (server 1) and food-serving facilities that provide dining-out services.

A menu recommendation system (server 1) according to a fifth aspect is configured by changing the configuration of any one of the first to fourth aspects such that the menus include information regarding one or more recipes. According to the fifth aspect, the usability is further improved.

A menu recommendation system (server 1) according to a sixth aspect is configured by changing the configuration of the fifth aspect such that the second information is information regarding an actual usage record for each recipe of the recommended menus. According to the sixth aspect, evaluation and recommendation can be made more minutely, and thus the usability is further improved.

A menu recommendation system (server 1) according to a seventh aspect is configured by changing the configuration of any one of the first to sixth aspects such that, when a user input indicating an acceptance of the recommended menus is received, the menu recommendation system performs request processing of making a request to deliver food ingredients (B1) required for the menus. According to the seventh aspect, it is possible to easily achieve cooperation between the menu recommendation system (server 1) and the food ingredients delivery service.

A menu recommendation system (server 1) according to an eighth aspect is configured by changing the configuration of any one of the first to seventh aspects such that the food cost for the target period (T1) is set in advance as a fixed charge. According to the eighth aspect, it is possible to easily implement a menu subscription service with a fixed charge.

A menu recommendation system (server 1) according to a ninth aspect is configured by changing the configuration of any one of the first to eighth aspects such that the evaluator (12) performs the evaluation based on condition information (D1) regarding at least one of the nutritional balance of food ingredients or the likes and dislikes of the user, in addition to the first information and the second information. According to the ninth aspect, the content of the recommended menus can be further improved.

A menu recommendation system (server 1) according to a tenth aspect is configured by changing the configuration of any one of the first to ninth aspects such that the predetermined processing includes processing of changing the content of the menus for the remaining period (T2) after the timing (t1) in the target period (T1). According to the tenth aspect, the content of the recommended menus can be further improved.

A menu recommendation system (server 1) according to an eleventh aspect is configured by changing the configuration of any one of the first to tenth aspects such that, when the menu recommendation system receives information indicating that the actual cost price of a specific food ingredient has varied, the menu recommendation system re-recommends menus that use food ingredients that have not yet been purchased by the user.

According to the eleventh aspect, it is possible to make a better menu recommendation according to the fluctuation in the price of food ingredients.

A menu recommendation system (server 1) according to a twelfth aspect is configured by changing the configuration of any one of the first to eleventh aspects such that, when the evaluator (12) receives a user input indicating a change of content of at least a portion of the recommended menus, the evaluator (12) determines whether the content of the menus after the change satisfies the target value (A1) and the nutritional balance of food ingredients. The menu recommendation system (server 1) further includes a notifier (communicator 10) that issues a notification of a result of the determination performed by the evaluator (12). The predetermined processing includes, if it is determined that the content of the menus after the change does not satisfy the target value (A1) and the nutritional balance, processing of re-recommending menus for the remaining period (T2) after the timing (t1) that satisfy the target value (A1) and the nutritional balance. According to the twelfth aspect, even when the user (5) directly makes a change to the recommended menus, menus generated by taking into consideration the target value (A1) and the nutritional balance can be easily re-recommended, and thus the usability is further improved.

A menu recommendation system (server 1) according to a thirteenth aspect is configured by changing the configuration of any one of the first to twelfth aspect such that the evaluator (12) performs the evaluation based on management expiration dates of food ingredients, in addition to the first information and the second information. According to the thirteenth aspect, the content of the recommended menus can be improved while preventing food ingredients from exceeding their management expiration dates.

A menu assisting system (100) according to a fourteenth aspect includes a server (1) that recommends menus for a target period (T1) based on a target value (A1) of a food cost for the target period (T1), and a presentation device (2) that is communicable with the server (1). The server (1) includes an evaluator (12) that evaluates the menus at an arbitrary timing (t1) in the target period (T1) and a processing unit (11) that performs predetermined processing based on a result of the evaluation performed by the evaluator (12). The evaluator (12) performs the evaluation based on first information regarding the content of the recommended menu and second information regarding an actual usage record of the recommended menus during a period from the start of the target period (T1) to the timing (t1). The presentation device (2) includes an inputter (24) that inputs the actual usage record of the menus, a communicator (21) that transmits the actual usage record to the server (1) and receives information regarding the result of the evaluation from server (1), an outputter (25) that outputs the information regarding the result of the evaluation, and a controller (22) that controls the inputter (24), the communicator (21), and the outputter (25). According to the fourteenth aspect, it is possible to provide a menu assisting system (100) with which it is possible to improve the content of the recommended menus.

A program according to a fifteenth aspect is a program that causes one or more processors included in the presentation device (2) of the menu assisting system (100) according to the fourteenth aspect to execute the following method. The method includes the steps of: acquiring an actual usage record of menus; transmitting the actual usage record to the server (1); receiving evaluation result information from the server (1); and outputting the evaluation result information. According to the fifteenth aspect, it is possible to provide a function of the presentation device (2), with which it is possible to improve the content of the recommended menus.

A menu recommendation method according to a sixteenth aspect recommends menus for a target period (T1) based on a target value for the food cost for the target period (T1). The menu recommendation method includes an evaluation step and a processing step. In the evaluation step, menu evaluation is performed at an arbitrary timing in the target period (T1). In the processing step, predetermined processing is performed based on the result of the evaluation performed in the evaluation step. In the evaluation step, the evaluation is performed based on first information regarding the content of recommended menus and second information regarding an actual usage record of the recommended menus during a period from the start of the target period (T1) to a timing (t1). According to the sixteenth aspect, it is possible to provide a menu recommendation method, with which it is possible to improve the content of the recommended menus.

A program according to a seventeenth aspect is a program that causes one or more processors to execute the menu recommendation method according to the sixteenth aspect. According to the seventeenth aspect, it is possible to provide a function with which it is possible to improve the content of the recommended menus.

The configurations according to the second to thirteenth aspects are not necessarily required for the menu recommendation system, and may be omitted as appropriate.

Also, a menu recommendation system (server 1) according to an embodiment includes an evaluator (12), a processing unit (11), and an actual usage record acquirer (102). The evaluator (12) recommends menus for a target period (T1). The processing unit (11) presents the menus recommended by the evaluator (12) to a user (5). The actual usage record acquirer (102) acquires, from the user (5), an actual usage record of the menus recommended by the evaluator (12) at an arbitrary timing (t1) in the target period (T1). The evaluator (12) performs at least one of reward processing or re-recommendation processing when a difference occurs between first information regarding the content of the menus recommended by the evaluator (12) and second information regarding the actual usage record acquired by the actual usage record acquirer (102) during a period from the start of the target period (T1) to the timing (t1), the reward processing being processing of giving a reward to the user (5) according to the difference, and the re-recommendation processing being processing of changing the content of menus for a remaining period (T2) after the timing (t1) in the target period (T1), and re-recommending the changed menus.

With this configuration, the content of the menus recommended to the user (5) can be improved. Also, with this configuration, the service provided to the user (5) can be improved.

Also, for example, the menu recommendation system (server 1) further includes a target value acquirer (101) that acquires a target value (A1) of a food cost for the target period (T1). The evaluator (12) recommends the menus for the target period (T1) based on the target value (A1) acquired by the target value acquirer (101).

With this configuration, the content of the menus recommended to the user (5) can be improved. Also, with this configuration, the service provided to the user (5) can be improved.

Also, for example, when the actual usage record acquirer (102) acquires food ingredient information regarding food ingredients (B2) personally acquired by the user (5), the evaluator (12) subtracts a cost that corresponds to the food ingredient information from the food cost, and recommends menus that use the food ingredients (B2).

With this configuration, it is possible to avoid the waste of the food ingredients (B2) while strictly sticking to the target value (A1) of the target period (T1).

Also, for example, when the actual usage record acquirer (102) acquires a user input indicating a cancellation of one of the recommended menus, the evaluator (12) performs processing of recommending dining-out or providing coupon information that is usable for the dining-out.

With this configuration, the user (5) can easily select not only cooking but also dining-out, and thus the usability is improved. Also, it is possible to easily enable cooperation between the menu recommendation system (server 1) and food-serving facilities that provide dining-out services.

Also, for example, the menus include information regarding one or more recipes.

With this configuration, the usability is further improved.

Also, for example, the second information is information regarding an actual usage record for each recipe of the recommended menus.

With this configuration, evaluation and recommendation can be made more minutely, and thus the usability is further improved.

Also, for example, when the evaluator (12) receives a user input indicating an acceptance of the recommended menus, the evaluator (12) performs request processing of making a request to deliver food ingredients required for the menus.

With this configuration, it is possible to easily achieve cooperation between the menu recommendation system (server 1) and the food ingredients delivery service.

Also, for example, the food cost for the target period (T1) is set in advance as a fixed charge.

With this configuration, it is possible to easily implement a menu subscription service with a fixed charge.

Also, for example, the evaluator (12) performs the evaluation based on condition information regarding at least one of the nutritional balance of food ingredients or the likes and dislikes of the user, in addition to the first information and the second information.

With this configuration, the content of the recommended menus can be further improved.

Also, for example, the menu recommendation system (server 1) further includes a cost information acquirer (103) that acquires cost information regarding a food ingredient cost. When the cost information acquirer (103) acquires the cost information indicating that the actual cost price of a food ingredient has varied, the evaluator (12) re-recommends menus that use food ingredients that have not yet been purchased by the user (5).

With this configuration, it is possible to make a better menu recommendation according to the fluctuation in the price of food ingredients.

Also, for example, when the predicted value of cost price of food ingredients is higher than a reference range, the evaluator (12) re-recommends menus to exclude the food ingredients. When the predicted value of cost price of food ingredients is lower than the reference range, the evaluator (12) re-recommends menus to include the food ingredients.

With this configuration, it is possible to make a better menu recommendation according to the fluctuation in the price of food ingredients.

Also, for example, when the actual usage record acquirer (102) acquires a user input indicating a change of content of at least a portion of the recommended menus, the evaluator (12) determines whether or not the content of the menus after the change satisfies the target value (A1) and the nutritional balance of food ingredients. The menu recommendation system (server 1) further includes a notifier (communicator 10) that issues a notification of a result of the determination performed by the evaluator (12). The evaluator (12) is configured to, if it is determined that the content of the menus after the change does not satisfy the target value (A1) and the nutritional balance, recommend menus for the remaining period (T2) after the timing (t1) that satisfy the target value (A1) and the nutritional balance.

With this configuration, even when the user (5) directly makes a change to the recommended menus, menus generated by taking into consideration the target value (A1) and the nutritional balance can be easily re-recommended, and thus the usability is further improved.

Also, for example, the evaluator (12) performs the evaluation based on management expiration dates of food ingredients, in addition to the first information and the second information.

With this configuration, the content of the recommended menus can be improved while preventing food ingredients from exceeding their management expiration dates.

Also, for example, a menu recommendation method includes an evaluation step (ST2), a processing step (ST3), and an actual usage record acquiring step (ST4). In the evaluation step (ST2), menus for a target period (T1) are recommended. In the processing step (ST3), the menus recommended in the evaluation step (ST2) are presented to a user (5). In the actual usage record acquiring step (ST4), at an arbitrary timing (t1) in the target period (T1), an actual usage record of the menus recommended in the evaluation step (ST2) is acquired from the user (5). In the evaluation step (ST2), when a difference occurs between first information regarding the content of the menus recommended in the evaluation step (ST2) and second information regarding the actual usage record acquired in the actual usage record acquiring step (ST4) during a period from the start of the target period (T1) to the timing (t1), at least one of reward processing of giving a reward to the user (5) according to the difference or re-recommendation processing of re-recommending menus for a remaining period (T2) that is after the timing (t1) in the target period (T1) by changing the content of the recommended menus.

With this configuration, it is possible to provide a menu recommendation method, with which it is possible to improve the content of menus recommended to the user (5). Also, with this configuration, it is possible to provide a menu recommendation method, with which it is possible to improve the service provided to the user (5).

Also, for example, a program causes one or more processors to execute the menu recommendation method described above.

With this configuration, it is possible to provide, to the user (5), a function of improving the content of menus recommended to the user (5). Also, with this configuration, it is possible to provide a function of improving the service provided to the user (5).

Also, for example, an information processing method includes first processing, second processing, and third processing. In the first processing, menus for a target period (T1) are acquired, and the acquired menus are presented to a user (5). In the second processing, at an arbitrary timing (t1) in the target period (T1), an actual usage record of the menus presented in the first processing is acquired from the user (5). In the third processing, when a difference occurs between first information regarding the content of the menus presented in the first processing and second information regarding the actual usage record acquired in the second processing during a period from the start of the target period (T1) to the timing (t1), information obtained through at least one of reward processing of giving a reward to the user (5) according to the difference or re-recommendation processing of re-recommending menus for a remaining period (T2) that is after the timing (t1) in the target period (T1) by changing the content of the recommended menus is presented to the user (5).

With this configuration, it is possible to provide an information processing method, with which it is possible to improve the content of menus provided to the user (5). Also, with this configuration, it is possible to provide an information processing method, with which it is possible to improve the service provided to the user (5).

The information processing method may be executed by, for example, an information terminal (2) owned by the user (5). In the information processing method described above, the reward processing and the re-recommendation processing do not necessarily need to be performed by the information terminal (2), and maybe performed by, for example, the menu recommendation system (server 1).

Also, for example, an information processing device (information terminal 2) includes a processing unit (controller 22). The processing unit has a first processing function, a second processing function, and a third processing function. The first processing function is a function of acquiring menus for a target period (T1) and presenting the acquired menus to the user (5). The second processing function is a function of acquiring an actual usage record of the menus presented by the first processing function from the user (5) at an arbitrary timing (t1) in the target period (T1). The third processing function is a function of, when a difference occurs between first information regarding the content of the menus presented by the first processing function and second information regarding the actual usage record acquired by the second processing function during a period from the start of the target period (T1) to the timing (t1), presenting, to the user (5), information obtained through at least one of reward processing of giving a reward to the user (5) according to the difference or re-recommendation processing of re-recommending menus for a remaining period (T2) that is after the timing (t1) in the target period (T1) by changing the content of the recommended menus.

With this configuration, it is possible to provide an information processing device, with which it is possible to improve the content of menus provided to the user (5). Also, with this configuration, it is possible to provide an information processing device, with which it is possible to improve the service provided to the user (5).

In the information processing device described above, the first processing function, the second processing function, and the third processing function may be executed by one processing unit, or may be executed by processing units that have different functions.

1. A menu recommendation system comprising:
an evaluator that recommends menus for a target period;
a processing unit that presents the menus recommended by the evaluator to a user; and
an actual usage record acquirer that acquires an actual usage record of the menus recommended by the evaluator from the user at an arbitrary timing in the target period,
wherein, when a difference occurs between first information regarding content of the menus recommended by the evaluator and second information regarding the actual usage record acquired by the actual usage record acquirer during a period from a start of the target period to the arbitrary timing, the evaluator performs at least one of reward processing of giving a reward to the user according to the difference or re-recommendation processing of re-recommending menus for a remaining period that is after the arbitrary timing in the target period by changing content of the menus recommended.

2. The menu recommendation system according to claim 1, further comprising:
a target acquirer that acquires a target value of a food cost for the target period,
wherein the evaluator recommends the menus for the target period based on the target value acquired by the target acquirer.

3. The menu recommendation system according to claim 1,
wherein, when the actual usage record acquirer acquires food ingredient information regarding a food ingredient personally acquired by the user, the evaluator subtracts a cost that corresponds to the food ingredient information from a food cost for the target period and recommends menus that use the food ingredient.

4. The menu recommendation system according to claim 1,
wherein, when the actual usage record acquirer acquires a user input indicating a cancellation of one of the menus recommended, the evaluator performs processing of recommending dining-out or processing of providing coupon information usable for the dining-out.

5. The menu recommendation system according to claim 1,
wherein the menus include information regarding one or more recipes.

6. The menu recommendation system according to claim 5,
wherein the second information is information regarding an actual usage record for each recipe of the menus recommended.

7. The menu recommendation system according to claim 1,
wherein, when the evaluator receives a user input indicating an acceptance of the menus recommended, the evaluator performs request processing of making a request to deliver food ingredients required for the menus.

8. The menu recommendation system according to claim 1,
wherein food cost for the target period is set in advance as a fixed charge.

9. The menu recommendation system according to claim 1,
wherein the evaluator performs evaluation on the menus based on condition information regarding at least one of a nutritional balance of food ingredients or likes and dislikes of the user, in addition to the first information and the second information.

10. The menu recommendation system according to claim 1, further comprising:
a cost information acquirer that acquires cost information regarding a food ingredient cost,
wherein, when the cost information acquirer acquires the cost information indicating that an actual food ingredient cost has varied, the evaluator re-recommends menus that use food ingredients that have not yet been purchased by the user.

11. The menu recommendation system according to claim 10,
wherein, when a predicted value of food ingredient cost price is higher than a reference range, the evaluator re-recommends the menus to exclude food ingredients whose cost price is higher, and when the predicted value of food ingredient cost price is lower than the reference range, the evaluator re-recommends the menus to include food ingredients whose cost price is lower.

12. The menu recommendation system according to claim 1, further comprising:
a target acquirer that acquires a target value of a food cost for the target period,
wherein, when the actual usage record acquirer acquires a user input indicating a change of content of at least a portion of the menus recommended, the evaluator determines whether the content of the menus after the change satisfies the target value and a nutritional balance of food ingredients,
the menu recommendation system further includes a notifier that issues a notification of a result of the determination performed by the evaluator, and
the evaluator re-recommends the menus for the remaining period after the arbitrary timing that satisfy the target value and the nutritional balance of food ingredients when it is determined that the content of the menus after the change does not satisfy the target value and the nutritional balance of food ingredients.

13. The menu recommendation system according to claim 1,
wherein the evaluator performs evaluation on the menus based on management expiration dates of food ingredients, in addition to the first information and the second information.

14. A menu recommendation method comprising:
performing evaluation to recommend menus for a target period;
performing processing to present the menus recommended in the performing of the evaluation to a user; and
acquiring an actual usage record of the menus recommended in the performing of the evaluation from the user at an arbitrary timing in the target period,
wherein the performing of the evaluation includes, when a difference occurs between first information regarding content of the menus recommended in the performing of the evaluation and second information regarding the actual usage record acquired in the acquiring during a period from a start of the target period to the arbitrary timing, performing at least one of reward processing of giving a reward to the user according to the difference or re-recommendation processing of re-recommending menus for a remaining period that is after the arbitrary timing in the target period by changing content of the menus recommended.

15. A non-transitory computer-readable recording medium storing a program that causes one or more processors to execute the menu recommendation method according to claim 14.

16. An information processing method comprising:
first processing of acquiring menus for a target period and presenting the menus acquired to a user;
second processing of acquiring an actual usage record of the menus presented in the first processing from the user at an arbitrary timing in the target period; and
third processing of, when a difference occurs between first information regarding content of the menus recommended in the first processing and second information regarding the actual usage record acquired in the second processing during a period from a start of the target period to the arbitrary timing, presenting, to the user, information obtained through at least one of reward processing of giving a reward to the user according to the difference or re-recommendation processing of re-recommending menus for a remaining period that is after the arbitrary timing in the target period by changing content of the menus recommended.

17. An information processing device comprising a processing unit,
the processing unit including:
a first processing function of acquiring menus for a target period and presenting the menus acquired to a user;
a second processing function of acquiring an actual usage record of the menus presented by the first processing function from the user at an arbitrary timing in the target period; and
a third processing function of, when a difference occurs between first information regarding content of the menus recommended by the first processing function and second information regarding the actual usage record acquired by the second processing function during a period from a start of the target period to the arbitrary timing, presenting, to the user, information obtained through at least one of reward processing of giving a reward to the user according to the difference or re-recommendation processing of re-recommending menus for a remaining period that is after the arbitrary timing in the target period by changing content of the menus recommended.
